(19) United States
(12) Patent Application Publication
(10) Pub. No.: US 2024/0280996 A1
(43) Pub. Date: Aug. 22, 2024

(54) CUSTOMER SERVICE ROBOT AND METHOD

(71) Applicant: TOSHIBA TEC KABUSHIKI KAISHA, Tokyo (JP)

(72) Inventors: Yousuke Otsuka, Nerima Tokyo (JP); Kazuki Nakamura, Ota Tokyo (JP); Yumiko Okuma, Koganei Tokyo (JP); Kizuku Inoue, Yokohama Kanagawa (JP); Sayaka Shimokawa, Yokohama Kanagawa (JP); Chisa Kokue, Ota Tokyo (JP); Naoki Hoshino, Hasuda Saitama (JP); Hideyuki Wada, Ota Tokyo (JP); Shogo Watada, Numazu Shizuoka (JP)

(21) Appl. No.: 18/406,245

(22) Filed: Jan. 8, 2024

(30) Foreign Application Priority Data
Feb. 22, 2023 (JP) 2023-026083

(51) Int. Cl. G05D 1/223; G05D 1/644; G06Q 30/015; G06Q 30/0601

(52) U.S. Cl. CPC G05D 1/2232; G05D 1/644; G06Q 30/015; G06Q 30/0631; G05D 2101/22; G05D 2105/315; G05D 2107/67

(57) ABSTRACT

A customer service robot autonomously moves to support shopping of a customer in a commercial facility including a plurality of stores. The customer service robot includes an action plan generating unit (a route setting unit) configured to set a store to be visited and a moving route in the commercial facility based on a store visiting purpose acquired from the customer and an operation control unit (a movement control unit) configured to cause the customer service robot to autonomously move along the moving route.

### CROSS-REFERENCE TO RELATED APPLICATION

This application is based upon and claims the benefit of priority from Japanese Patent Application No. 2023-026083, filed on Feb. 22, 2023, the entire contents of which are incorporated herein by reference.

### FIELD

Embodiments described herein relate generally to a customer service robot and a method.

### BACKGROUND

There has been proposed a store reception system that acquires a store visiting purpose of a customer and guides the customer to a counter position corresponding to the store visiting purpose.

There has been disclosed a system that performs customer service corresponding to a store visiting purpose of a customer. However, the disclosed system is based on the premise that the system is applied to a scene where a store visiting purpose of a customer and customer service corresponding to the store visiting purpose are limited to a certain degree as in, for example, a financial institution. Therefore, it is difficult to apply the disclosed content to, for example, a scene where a customer shops around in a commercial facility where store visiting purposes of customers are various. On the other hand, in the commercial facility, it is desired to perform customer service for a customer visiting the commercial facility for the first time equivalent to customer service for a customer visiting the commercial facility many times.

### BRIEF DESCRIPTION OF THE DRAWINGS

FIG. 1 is a diagram illustrating an example of a configuration of a customer service support system according to an embodiment;

FIG. 2 is a front perspective view illustrating an example of a customer service robot to the according embodiment;

FIG. 3 is a rear perspective view illustrating the example of the customer service robot;

FIG. 4 is a diagram illustrating an example of a hardware configuration of the customer service robot;

FIG. 5 is a diagram illustrating an example of a hardware configuration of a store device according to the embodiment;

FIG. 6 is a diagram illustrating an example of a hardware configuration of a server device according to the embodiment;

FIG. 7 is a diagram illustrating an example of a data configuration of a store management table;

FIG. 8 is a diagram illustrating an example of a data configuration of a commodity master;

FIG. 9 is a diagram illustrating an example of a data configuration of a robot management table;

FIG. 10 is a diagram illustrating an example of a data configuration of a user management table;

FIG. 11 is a diagram illustrating an example of a data configuration of a transaction management table;

FIG. 12 is a functional block diagram illustrating an example of functional configurations of the customer service robot, the store device, and the server device;

FIG. 13 is a diagram illustrating an example of a check-in screen displayed on a front display unit of the customer service robot at a check-in time;

FIG. 14 is a diagram illustrating an example of a screen displayed on the front display unit of the customer service robot if a customer instructs a store visiting purpose;

FIG. 15 is a diagram illustrating an example of a screen displayed on the front display unit of the customer service robot if the customer selects a store that the customer desires to visit;

FIG. 16 is a diagram illustrating an example of schematic information of a generated moving route displayed on the front display unit of the customer service robot;

FIG. 17 is a first diagram for explaining a method of changing store touring order;

FIG. 18 is a second diagram for explaining the method;

FIG. 19 is a third diagram for explaining the method;

FIG. 20 is a first diagram for explaining a method of deleting a store;

FIG. 21 is a second diagram for explaining the method;

FIG. 22 is a diagram illustrating an example of guidance information displayed on a rear display unit while the customer service robot is moving in a leading mode;

FIG. 23 is a diagram illustrating an example of a basic operation screen displayed on the front display unit of the customer service robot;

FIG. 24 is a diagram illustrating an example of a commodity screen;

FIG. 25 is a flowchart illustrating an example of a flow of processing performed by the customer service robot;

FIG. 26 is a flowchart illustrating an example of a flow of check-in processing;

FIG. 27 is a flowchart illustrating an example of a flow of action plan setting processing;

FIG. 28 is a flowchart illustrating an example of a flow of movement control processing;

FIG. 29 is a flowchart illustrating an example of a flow of store cooperation processing; and

FIG. 30 is a flowchart illustrating an example of a flow of purchase support processing.

### DETAILED DESCRIPTION

An aspect of embodiments is to provide a customer service robot and a method that can perform customer service for a customer visiting a commercial facility for the first time equivalent to customer service for a customer accustomed to the commercial facility.

A customer service robot in an embodiment is a robot that autonomously moves to support shopping of a customer in a commercial facility including a plurality of stores, the robot including a route setting unit and a movement control unit. The route setting unit sets a store to be visited and a moving route in the commercial facility based on a store visiting purpose acquired from the customer. The movement control unit causes the customer service robot to autonomously move along the moving route.

An embodiment t is explained in detail below with reference to the drawings. In the embodiment explained below, a form in which a customer service support system 1 is applied to a commercial facility such as a shopping center or a station building where a plurality of stores are accommodated. Note that embodiments are not limited by the embodiment explained below.

### (System Configuration of the Customer Service Support System)

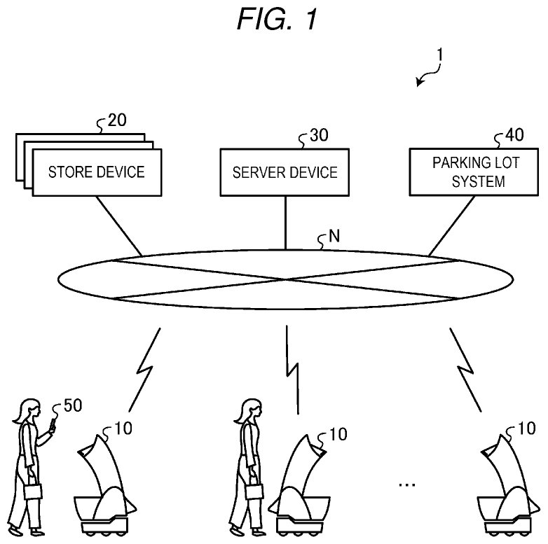

FIG. 1 is a diagram illustrating an example of a configuration of the customer service support system according to the embodiment. As illustrated in FIG. 1, the customer service support system 1 includes a customer service robot 10, a store device 20, a server device 30, a parking lot system 40, and a customer terminal 50. The customer service robot 10, the store device 20, the server device 30, and the parking lot system 40 are connected to a network N such as a LAN (Local Area Network).

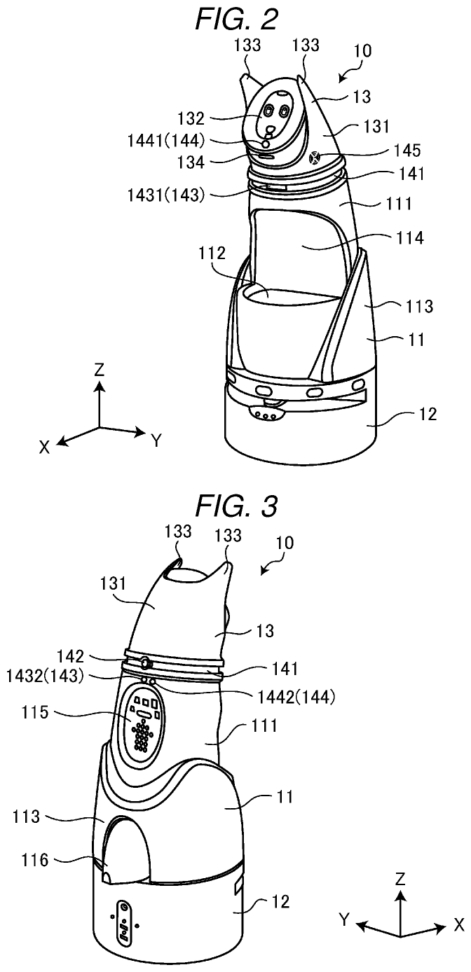

The customer service robot 10 is a mobile robot of an autonomously moving type. A plurality of customer service robots 10 are provided in the commercial facility and support actions of customers who use the commercial facility. Note that the number of the customer service robots 10 is not limited to the example illustrated in FIG. 1. A detailed configuration of the customer service robot 10 is explained below (see FIGS. 2 and 3).

The store device 20 is an information processing device such as a POS terminal or a store server provided in each of the stores present in the commercial facility. The store device 20 executes various kinds of processing relating to the store under control of a not-illustrated processor.

The server device 30 is a server device of the customer service support system 1. The server device 30 is implemented by an information processing device such as a PC (Personal Computer). The server device 30 stores and manages various data relating to data processing of the customer service support system 1. For example, the server device 30 manages a present position and an operation state of the customer service robot 10. For example, the server device 30 manages a commodity registered via the customer service robot 10 and a commodity purchased via the customer service robot 10.

Note that, in this embodiment, it is assumed that the server device 30 is implemented by a single information processing device. However, the server device 30 may be a Cloud server implemented by a plurality of information processing devices connected by a network. If the server device 30 is the Cloud server, the server device 30 may include store servers of the stores.

The parking lot system 40 is provided in a parking lot of the commercial facility and manages entering and leaving states and parking positions of vehicles. For example, the parking lot system 40 includes a gate device provided at an entrance of the parking lot, monitoring cameras provided to cover parking positions of the parking lot, and a parking lot management server (all of which are not illustrated) and manages parking positions and entering and leaving times based on registration numbers attached to vehicles (numbers described on number plates). For example, the parking lot management server recognizes a registration number of a vehicle from an image of the vehicle captured by the monitoring camera and stores the registration number in correlation with information indicating a parking position in the parking lot. The parking lot management server stores entering and leaving times of a vehicle obtained via the gate device in correlation with a registration number of the vehicle and collects a fee corresponding to a parking time via the gate device or the customer service robot 10.

The customer terminal 50 is a portable terminal device such as a smartphone or a tablet terminal carried by a customer. In this embodiment, the customer terminal 50 is used, for example, at a check-in operation time when the customer starts using the customer service robot 10. As an example, the check-in operation is performed by inputting a user ID capable of identifying the customer. Note that the customer service robot 10 can also be used even in a state in which the user ID is not input.

As an example, an application program relating to cooperation with the customer service robot 10 (hereinafter referred to as cooperation program as well) is introduced into the customer terminal 50. A processor of the customer terminal 50 cooperates with the cooperation program to execute various kinds of processing for cooperating with the customer service robot 10. For example, the processor of the customer terminal 50 causes, according to operation of the customer, a display device included in the customer terminal 50 to display a code symbol including a user ID. The processor of the customer terminal 50 is capable of establishing short-range wireless communication with the customer service robot 10 according to operation of the customer.

In the customer service support system 1 explained above, a customer visiting the commercial facility can enjoy customer service support by the customer service robot 10. Specifically, the customer can receive customer service support by the customer service robot 10 cooperating with the customer by operating the customer service robot 10. The customer service robot 10 executes various kinds of processing such as recommendation of a store to which the customer visits and support relating to purchase of a commodity while moving in the commercial facility together with the customer.

Note that the customer service support system 1 is not limited to the configuration illustrated in FIG. 1. For example, the customer terminal 50 may not be included in the customer service support system 1. External systems usable by the customer such as EC (Electronic Commerce) sites of stores present in the commercial facility, EC sites operated by other stores present outside the commercial facility, and various search sites may be included in the customer service support system 1. In this case, the customer service robot 10, the server device 30, and the like of the customer service support system 1 may be configured to be capable of referring to, based on a user ID or the like explained below, a purchase history of commodities purchased by the customer in the EC sites, a search history of matters searched by the customer in the search sites, and the like.

### (Configuration of the Customer Service Robot)

A configuration of the customer service robot 10 is explained with reference to FIGS. 2 and 3. FIG. 2 is a front exterior view illustrating an example of the customer service robot according to the embodiment. FIG. 3 is a rear exterior view illustrating the example of the customer service robot according to the embodiment.

The configuration of the customer service robot 10 is explained using three axial directions of an X axis, a Y axis, and a Z axis orthogonal to one another in FIGS. 2 and 3. The X axis is an axis piercing through the customer service robot 10 back and forth and extending from the rear to the front of the customer service robot 10. The Y axis is an axis piercing through the customer service robot 10 to the left and the right and extending from the left side to the right side if the customer service robot 10 is seen from the front. The Z axis is an axis piercing through the customer service robot 10 up and down and extending from the bottom to the top of the customer service robot 10. In the following explanation, an X-axis positive direction side of the customer service robot 10 is referred to as front side of the customer service robot 10 as well. An X-axis negative direction side of the customer service robot 10 is referred to as rear side of the customer service robot 10 as well.

The customer service robot 10 includes a main body unit 11, a moving unit 12, and an interface unit 13. The customer service robot 10 preferably has an exterior simulating a character such as an animal in order to give psychological sense of security to customers. The customer service robot 10 in this embodiment has an exterior simulating a kangaroo. The main body unit 11 and the moving unit 12 correspond to the body of the kangaroo and the interface unit 13 corresponds to the head of the kangaroo.

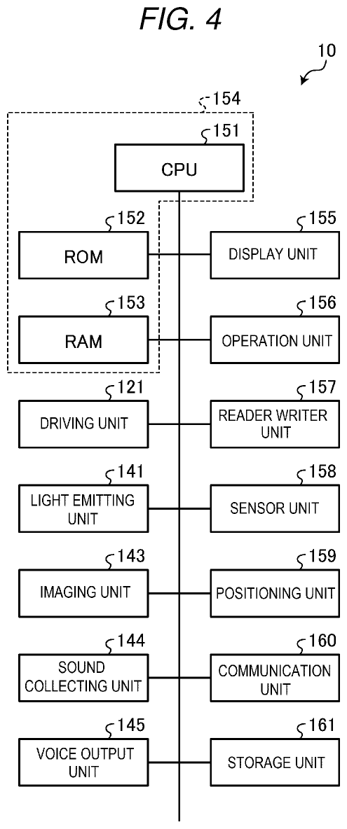

The main body unit 11 includes a substantially cylindrical housing 111, a placing table 112, and a cover unit 113 provided to cover the periphery of the placing table 112 from the lower rear side to the front side of the housing 111. An opening 114 is provided on the front side of the housing 111 to make it possible to access the inside of the housing 111 through the opening 114. The placing table 112 is provided in a state in which the placing table 112 projects from the inside of the housing 111 to the front side. An article such as a commodity can be placed on the placing table 112. A reader writer unit 157 (see FIG. 4) explained below may be provided in the placing table 112. The placing table 112 is designed to correspond to the brood pouch (bag) of the kangaroo in the exterior of the customer service robot 10.

In this embodiment, a part of the placing table 112 is projected from the housing 111. However, not only this, but the placing table 112 may be provided on the inside of the housing 111 to make it possible to store an article in the housing 111. An upward part of the placing table 112 is covered by the housing 111. However, not only this, but the upward part of the placing table 112 may not be covered.

An open-closable shielding member such as a lid or a door may be provided in the opening 114 to shield an article placed on the placing table 112. The shielding member may be formed of a light transmissive member such that a state of the inside can be viewed from the outside. Further, an electronic lock or the like may be provided to make it possible to lock a closed state by the shielding member. Consequently, it is possible to prevent the article from dropping from the placing table 112, for example, if the customer service robot 10 is moving. It is possible to prevent the article from being carelessly taken out from the placing table 112.

On the other hand, a rear display unit 115 is provided on the rear side of the housing 111. The rear display unit 115 is, for example, a touch panel display and displays various kinds of information under control of a control unit 154 explained below (see FIG. 4). A tail unit 116 corresponding to the tail of the kangaroo is provided in a rear side lower part of the housing 111.

The moving unit 12 is provided below the main body unit 11 and supports the main body unit 11 from below. The moving unit 12 includes a driving unit 121 (see FIG. 4) including a motor and a rotating mechanism. A plurality of driving wheels, a plurality of auxiliary wheels, and the like driven to rotate by the driving unit 121 (all of which are not illustrated) are provided on the bottom surface side of the moving unit 12.

The driving unit 121 is capable of causing the customer service robot 10 to travel by driving to rotate the driving wheels. Specifically, the driving unit 121 causes the customer service robot 10 to travel in any direction at any speed by changing rotating speed and a rotating direction of the driven driving and a driving source. Note that, in this embodiment, the driving unit 121 causes the customer service robot 10 to travel in a state in which the front side of the customer service robot 10 is directed to a traveling direction. However, not only this, but the driving unit 121 may cause the customer service robot 10 to travel in a state in which the rear side of the customer service robot 10 is directed to the traveling direction.

The interface unit 13 is provided above the main body unit 11. The interface unit 13 includes a housing 131 and a front display unit 132. An operation surface inclined to the front side is formed from the top to the bottom on the front side of the housing 131. The front display unit 132 is provided on the operation surface. The front display unit 132 is, for example, a touch panel display and displays various kinds of information under the control of the control unit 154 explained below. A pair of ear units 133 corresponding to the ears of the kangaroo is provided in the housing 131.

A slit 134 into which a commodity card explained below can be inserted is formed below the operation surface of the housing 111. A reader writer unit 157 (see FIG. 4) capable of reading and writing a wireless tag such as an RFID tag is provided on the inside of the slit 134. Under the control of the control unit 154 explained below, the reader writer unit 157 reads information capable of specifying a commodity from the wireless tag of the commodity card inserted into the slit 134 and writes, in the wireless tag, information indicating that a commodity was already purchased.

The customer service robot 10 includes a light emitting unit 141 between the main body unit 11 and the interface unit 13. The light emitting unit 141 includes a light emitting element such as an LED (Light Emitting Diode) and emits light according to the control of the control unit 154 explained below. The light emitting unit 141 includes light emitting elements of a plurality of colors and switches a light emission color according to the control of the control unit 154 explained below. The light emitting unit 141 emits light to thereby inform various states such as a state of the customer service robot 10 and a commodity purchase state. Note that, in this embodiment, an example is explained in which the light emitting unit 141 is provided in a collar shape in a position corresponding to the neck of the kangaroo. However, a position where the light emitting unit 141 is provided and a shape of the light emitting unit 141 are not limited to this.

The customer service robot 10 includes a stop button 142 on the rear side. The stop button 142 is an operation piece for stopping traveling of the customer service robot 10. If the stop button 142 was operated, the customer service robot 10 stops traveling. Note that, in this embodiment, an example is explained in which the stop button 142 is provided in a position corresponding to the neck of the kangaroo. However, a position where the stop button 142 is provided is not limited to this.

The customer service robot 10 includes a front imaging unit 1431 on the front side and includes a rear imaging unit 1432 on the rear side. The front imaging unit 1431 and the rear imaging unit 1432 include an imaging element such as a CCD (Charge Coupled Device) or a CMOS (Complementary MOS).

The front imaging unit 1431 and the rear imaging unit 1432 image the periphery of the customer service robot 10 in order to grasp, for example, a customer present around the customer service robot 10 and an obstacle in a traveling direction of the customer service robot 10. The front imaging unit 1431 is also used to image a code symbol such as a barcode or a two-dimensional code attached to a commodity, a code symbol displayed on the customer terminal 50, and the like presented by the customer. In other words, the front imaging unit 1431 acquires the code symbol such as the barcode or the two-dimensional code attached to the commodity. Note that installation positions of the front imaging unit 1431 and the rear imaging unit 1432 included in the customer service robot 10 are not limited to an illustrated example. A plurality of front imaging units 1431 and a plurality of rear imaging units 1432 may be provided. In the following explanation, if the front imaging unit 1431 and the rear imaging unit 1432 are expressed without being distinguished, the front imaging unit 1431 and the rear imaging unit 1432 are sometimes simply referred to as imaging unit 143.

The customer service robot 10 includes a front sound collecting unit 1441 on the front side and includes a rear sound collecting unit 1442 on the rear side. The front sound collecting unit 1441 collects voice (for example, utterance of the customer) on the front side of the customer service robot 10. The rear sound collecting unit 1442 collects voice (for example, utterance of the customer) on the rear side of the customer service robot 10. The front sound collecting unit 1441 and the rear sound collecting unit 1442 are, for example, omni-directional microphones. Each of the front sound collecting unit 1441 and the rear sound collecting unit 1442 may be a microphone array in which a plurality of microphones are arranged in an array. For example, a directional characteristic of the microphone array configuring the front sound collecting unit 1441 is directed to a customer presence direction detected by the front imaging unit 1431, whereby the utterance of the customer can be more clearly collected. Similarly, a directional characteristic of the microphone array configuring the rear sound collecting unit 1442 is directed to a customer presence direction detected by the rear imaging unit 1432, whereby the utterance of the customer can be more clearly collected.

The customer service robot 10 includes a voice output unit 145. The voice output unit 145 outputs voice and sound of the customer service robot 10. The voice output unit 145 is, for example, a speaker. Note that the numbers and installation positions of the front sound collecting unit 1441, the rear sound collecting unit 1442, and the voice output unit 145 included in the customer service robot 10 are not limited to an illustrated example. In the following explanation, if the front sound collecting unit 1441 and the rear sound collecting unit 1442 are expressed without being distinguished, the front sound collecting unit 1441 and the rear sound collecting unit 1442 are sometimes simply referred to as sound collecting unit 144.

The customer service robot 10 includes various sensor units 158 (see FIG. 4). For example, the customer service robot 10 includes a distance measurement sensor. The distance measurement sensor is provided, for example, on each of the front side and the rear side of the customer service robot 10 and detects an object around the customer service robot 10 and detects a distance to the object. A sensing result of the distance measurement sensor is output to the control unit 154 explained below and used for, for example, collision avoidance at a traveling time. Note that the distance measurement sensor can be implemented by, for example, a sensor device that performs object detection and measurement of a distance with a captured image or ultrasound or a sensor device such as LiDAR (Light Detection and ranging) that performs object detection with a laser beam.

The customer service robot 10 may include, as the sensor unit 158, a vibration detection sensor capable of detecting contact and a shock on the main body unit 11. The customer service robot 10 may include a GPS (Global Positioning System) sensor as the sensor unit 158 or a positioning unit 159 (see FIG. 4). The GPS sensor detects, for example, a presence position of the customer service robot 10 in the commercial facility. The customer service robot 10 may include, as the sensor unit 158, a speed sensor that detects moving speed of the customer service robot 10 and a steering angle sensor and a gyro sensor that detect a moving direction of the customer service robot 10.

Note that the configuration of the customer service robot 10 is not limited to the illustrated example. For example, the customer service robot 10 includes a battery (not illustrated) that supplies driving power of the customer service robot 10 itself to the main body unit 11 and the moving unit 12. The interface unit 13 may include a reader device that reads information from a card medium such as an IC card or a credit card. The customer service robot 10 may include a cash automatic adjustment machine and a printer.

### (Hardware Configuration of the Customer Service Robot)

A hardware configuration of the customer service robot 10 is explained with reference to FIG. 4. FIG. 4 is a diagram illustrating an example of a hardware configuration of the customer service robot according to the embodiment.

As illustrated in FIG. 4, the customer service robot 10 includes a CPU (Central Processing Unit) 151, a ROM (Read Only Memory) 152, and a RAM (Random Access Memory) 153.

The CUP 151 is an example of a processor and collectively controls the units of the customer service robot 10. The ROM 152 stores various programs. The RAM 153 is a work space in which programs and various data are loaded.

The CPU 151, the ROM 152, and the RAM 153 are connected via a bus and configures a control unit 154 having a computer configuration. In the control unit 154, the CPU 151 operates according to a program stored in the ROM 152 or a storage unit 161 and loaded in the RAM 153 to thereby execute various kinds of processing.

The customer service robot 10 includes the driving unit 121, the light emitting unit 141, the imaging unit 143 including the front imaging unit 1431 and the rear imaging unit 1432, the sound collecting unit 144 including the front sound collecting unit 1441 and the rear sound collecting unit 1442, and the voice output unit 145 explained above. The sound collecting unit 144 collects voice, for example, utterance of the customer around the customer service robot 10 and outputs a voice signal of the collected voice to the CPU 151. The voice output unit 145 outputs the voice under control of the CPU 151.

The customer service robot 10 includes a display unit 155, an operation unit 156, a reader writer unit 157, a sensor unit 158, a positioning unit 159, a communication unit 160, and the storage unit 161.

The display unit 155 is a display device such as the rear display unit 115 and the front display unit 132 explained above. The display unit 155 is configured by an LCD (Liquid Crystal Display) or the like. The display unit 155 displays various kinds of image information under the control of the CPU 151.

The operation unit 156 is an input device such as touch panels provided in the rear display unit 115 and the front display unit 132 and the stop button 142. The operation unit 156 outputs, to the CPU 151, operation content input via the input device. Note that the operation unit 156 may output voice (for example, utterance of the customer) input via the sound collecting unit 144 to the CPU 151 as operation content.

The reader writer unit 157 is a reader writer device capable of performing writing in and reading from a wireless tag. The reader writer unit 157 includes an antenna (not illustrated) for irradiating a radio wave and transmits writing target data via the antenna to write the data in the wireless tag. The reader writer unit 157 acquires, via the antenna, a radio wave emitted by the wireless tag to read data from the wireless tag.

The sensor unit 158 is various sensor devices such as the distance measurement sensor and the GPS sensor explained above. The sensor unit 158 outputs a sensing result obtained by sensing to the CPU 151.

The positioning unit 159 measures a present position of the customer service robot 10. The positioning unit 159 can be implemented by, for example, a positioning technique using a GPS sensor. The positioning unit 159 may be implemented by a position measuring device that makes use of a positioning technique such as beacon positioning. In this case, by providing terminals adapted to the positioning technique such as the beacon positioning in positions of the commercial facility, a present position of the customer service robot 10 can be measured (specified) by the positioning system formed by the terminals and the positioning unit 159.

The communication unit 160 is a wireless communication interface connectable to the network N. The communication unit 160 performs communication with external devices such as the server device 30 and the store device 20 via the network N. The communication unit 160 includes a short-range wireless communication function such as Bluetooth (registered trademark). For example, the communication unit 160 performs short-range wireless communication with the customer terminal 50 present around the customer service robot 10.

The storing unit 161 includes a storage medium such as a HDD (Hard Disk Drive) or a flash memory and maintains stored content even if a power supply is interrupted. The storage unit 161 stores programs executable by the CPU 151 and various kinds of setting information.

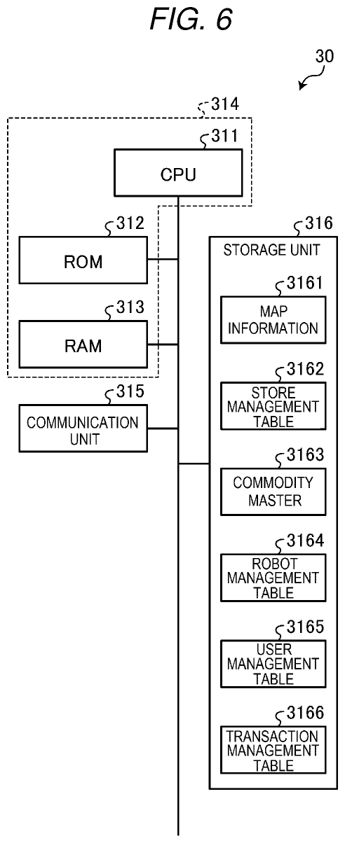

Information stored by the storing unit 161 is not limited to the illustrated example. For example, the storage unit 161 may store map information 3161 explained below (see FIG. 6), a facility information table, a commodity master of stores, a transaction management table relating to the customer service robot 10.

### (Hardware Configuration of the Store Device)

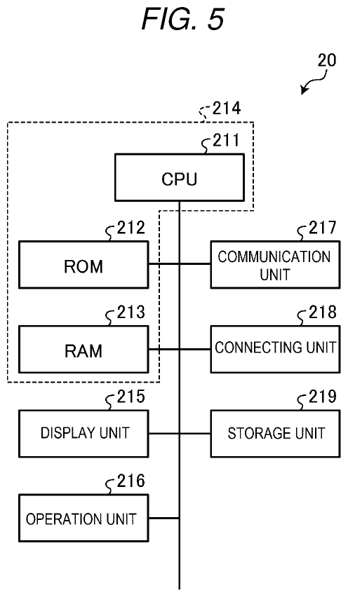

A hardware configuration of the store device 20 is explained with reference to FIG. 5. FIG. 5 is a diagram illustrating an example of a hardware configuration of the store device according to the embodiment.

Subsequently, the hardware configuration of the store device 20 is explained. FIG. 5 is a diagram illustrating an example of the hardware configuration of the store device 20. As illustrated in FIG. 5, the store device 20 includes a CPU 211, a ROM 212, and a RAM 213.

The CPU 211 is an example of a processor and collectively controls the units of the store device 20. The ROM 212 stores various programs. The RAM 213 is a work space in which programs and various data are loaded.

The CPU 211, the ROM 212, and the RAM 213 are connected via a bus or the like and configures a control unit 214 having a computer configuration. In the control unit 214, the CPU 211 operates according to a program stored in the ROM 212 or a storage unit 219 and loaded in the RAM 213 to thereby execute various kinds of processing.

The store device 20 includes a display unit 215, an operation unit 216, a communication unit 217, a connecting unit 218, and the storage unit 219.

The display unit 215 includes a display device such as an LCD. The display unit 215 displays various kinds of information under control of the CPU 211. The operation unit 216 includes an input device such as a keyboard or a pointing device. The operation unit 216 outputs operation content input via the input device to the CPU 211. Note that the operation unit 216 may be a touch panel provided on the display unit 215.

The communication unit 217 is a wireless communication interface connectable to the network N. The communication unit 217 performs communication with external devices such as the customer service robot 10 and the server device 30. The communication unit 217 may have a short-range wireless communication function and may perform communication with the customer service robot 10 by short-range wireless communication.

The connecting unit 218 is an interface for connecting various devices provided in a store. For example, a reader device capable of reading a code symbol, a printer device, and the like are connected to the connecting unit 218. Electronic shelf labels or the like installed in positions of display shelves of the store may be connected to the connecting unit 218. If the electronic shelf labels are connected, the control unit 214 performs control for causing the electronic shelf label displayed in a display position of a commodity to display a commodity name, a price, and the like of the commodity. If a light emitting element such as an LED is provided in the electronic shelf label, the control unit 214 performs, based on an instruction from the operation unit 216 or the external device such as the customer service robot 10, control for, for example, causing the light emitting element provided in the electronic shelf label to emit light.

The storage unit 219 includes a storage medium such as a HDD (Hard Disk Drive) or a flash memory and maintains stored contents even if a power supply is interrupted. The storage unit 219 stores programs executable by the CPU 211 and various kinds of setting information.

The storage unit 219 may store a commodity master, which is a master file storing information concerning commodities sold in the store. That is, in this embodiment, a commodity master 3163 (see FIG. 8) is explained as being stored by the server device 30. However, the store device 20 may acquire, from the commodity master 3163 stored by the server device 30, only information relating to commodities to which a store ID of the store is given and store the information in the storage unit 219. In this case, if performing registration and settlement for a commodity purchased by the customer, the customer service robot 10 acquires commodity information by referring to, according to necessity, the commodity master stored by the storage unit 219.

### (Hardware Configuration of the Server Device)

A hardware configuration of the server device 30 is explained with reference to FIG. 6. FIG. 6 is a diagram illustrating an example of a hardware configuration of the server device according to the embodiment.

As illustrated in FIG. 6, the server device 30 includes a CPU 311, a ROM 312, and a RAM 313.

The CPU 311 is an example of a processor and collectively controls the units of the server device 30. The ROM 312 stores various programs. The RAM 313 is a work space in which programs and various data are loaded.

The CPU 311, the ROM 312, and the RAM 313 are connected via a bus and configures a control unit 314 having a computer configuration. In the control unit 314, the CPU 311 operates according to a control program stored in the storage unit 316 and loaded in the RAM 313 to thereby execute various kinds of processing.

The server device 30 includes a communication unit 315 and a storage unit 316. The communication unit 315 is a wired or wireless communication interface connectable to the network N. The communication unit 315 performs communication with external devices such as the customer service robot 10, the store device 20, and the parking lot system 40 via the network N.

The storage unit 316 includes a storage medium such as a HDD or a flash memory and maintains stored content even if a power supply is interrupted. The storage unit 316 stores programs executable by the CPU 311 and various kinds of setting information.

The storage unit 316 stores map information 3161, a store management table 3162, a commodity master 3163, a robot management table 3164, a user management table 3165, and a transaction management table 3166.

The map information 3161 is information indicating a map of the commercial facility. In the map information 3161, positions of the stores present in the commercial facility and store IDs capable of identifying the stores in correlation with the positions of the stores are stored. For example, if the commercial facility has multilayer story structure, the map information 3161 is prepared for each of floors. In the map information 3161, positions of common spaces (for example, elevators, escalators, rest rooms, and resting places) other than the stores are also stored in correlation with identifiers. Information concerning the stores and the common spaces is described in, for example, a polygon format indicating shapes of those facilities and stored in the map information 3161. Further, in the map information 3161, information concerning passages inside the commercial facility is stored as link data such as point rows and surface rows configuring the passages.

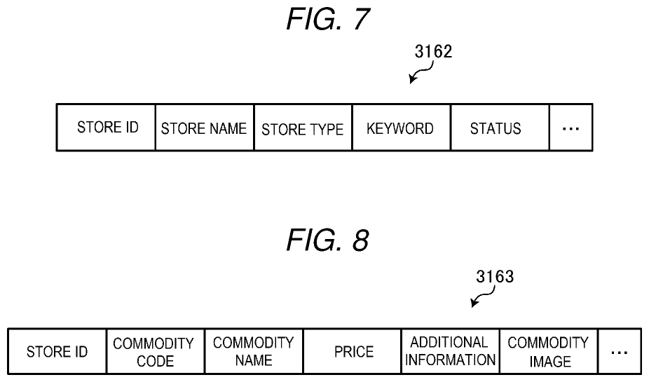

The store management table 3162 is a data table for storing and managing information concerning the stores present in the commercial facility. FIG. 7 is a diagram illustrating an example of a data configuration of the store management table 3162. As illustrated in FIG. 7, the store management table 3162 stores store information such as a store name, a store type, a keyword, and a status in correlation with store IDs of the stores present in the commercial facility. Information indicating names of the stores corresponding to the store IDs is stored in an item of the store name.

For example, information indicating business types of the stores and classifications of commodities sold in the stores is stored in an item of the store type. For example, in the item of the store type, large classifications such as a restaurant and a retail store, middle classifications indicating classifications of commodities to be sold (for example, Japanese foods, Chinese foods, a clothing store, and an electrical appliance store), more detailed small classifications (sushi, soba, men's clothes, women's clothes, and the like), and the like can also be defined stepwise.

One or a plurality of keywords indicating features and characteristics of the stores are stored in an item of the keyword. The keywords can be optionally set for each of the stores. However, keywords classified by indicators based on store visiting actions of customers are preferably used. A keyword classified based on a common indicator is preferably used for stores in the same business type and the same genre.

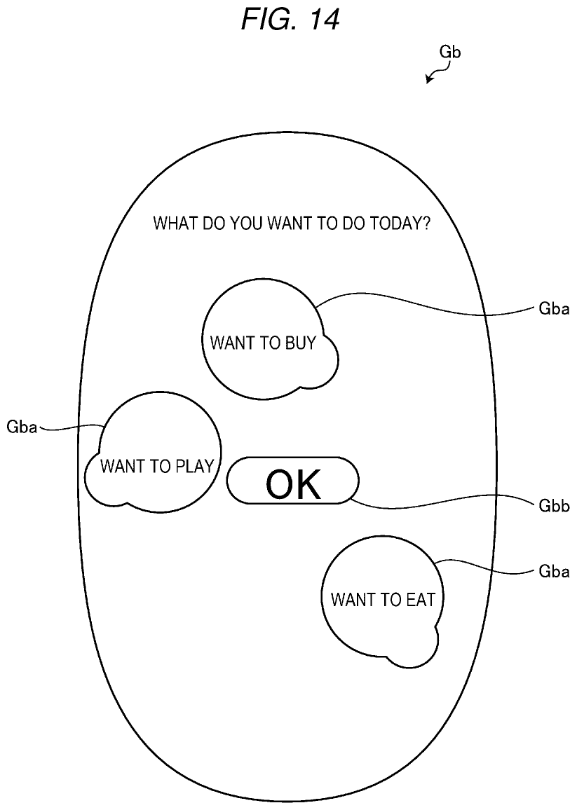

As an example, a keyword such as “want to eat” can be set in a restaurant, a keyword such as “want to buy” can be set in a retail store such as a clothing store, and a keyword such as “want to play” can be set in a store such as a game center. Keywords such as “for men”, “for women”, and “for families” may be set based on characteristics of commodities sold by the stores. Note that the keywords can be keywords in searching for a purpose of a customer on a store visiting purpose check screen Gb explained below (see FIG. 14). Therefore, it is preferable to set a name based on a store visiting action of the customer.

Information indicating states such as congestion situations of the stores and store opening and closing is stored in an item of the status. By using the information stored in the status, for example, if an action plan of a customer explained below is set, it is possible to guide the customer to a store as unoccupied as possible. It is possible to avoid guidance to a closed store.

Note that the data configuration of the store management table 3162 is not limited to the example illustrated in FIG. 7. For example, the store management table 3162 may store, in correlation with a store ID, position information indicating a position of a store corresponding to the store ID. Further, the store management table 3162 may store information concerning a common space other than the stores.

The commodity master 3163 is a data table for storing and managing information concerning commodities sold in the stores belonging to the commercial facility.

FIG. 8 is a diagram illustrating an example of a data configuration of the commodity master 3163. As illustrated in FIG. 8, the commodity master 3163 stores commodity information such as a commodity name, a price, additional information, and a commodity image in correlation with a store ID of a store and commodity codes of commodities sold in the store. The store ID is an example of an identifier capable of identifying each of the stores. The commodity code is an example of an identifier capable of identifying a type of a commodity.

A name of the commodity corresponding to the commodity code is stored in an item of the commodity name. A price of the commodity corresponding to the commodity code is stored in an item of the price. Additional information concerning the commodity corresponding to the commodity code is stored in an item of the additional information. For example, a type and the like of the commodity are stored in the item of the additional information. If the commodity is clothing, a size, a color, a design, a material, a brand, and the like are stored in the item of the additional information. Image data representing the commodity corresponding to the commodity code is stored in an item of the commodity image.

Note that the data configuration of the commodity master 3163 is not limited to the example illustrated in FIG. 8. For example, the commodity master 3163 may store the weight of the commodity in correlation with the commodity code. The commodity master 3163 may store, in correlation with the commodity code, information capable of specifying display positions of the commodity in the stores and electronic shelf labels disposed in the display positions.

Commodities registered in the commodity master 3163 are not limited to commodities that can be actually received and carried back from a store (hereinafter referred to as store commodities as well). For example, the commodities registered in the commodity master 3163 may be services.

For example, in a showroom type store that performs only exhibition of commodities, in some case, a commodity code of an exhibited commodity is read, the commodity is registered and settled, and the commodity is handed by a receiving method (delivery or reception at a reception counter or the like) designated by a customer. In such a case, information indicating whether the commodity corresponding to the commodity code is a store commodity explained above that can be received in the store or a provisional commodity explained below that cannot be received in the store may be stored as the additional information. For example, if settlement of the exhibited commodity is not performed in the store but is performed in an EC site operated by the store, an address and the like of the EC site may be stored as the additional information. That is, the exhibited commodity is a commodity, a real product of which cannot be received in the store. In the following explanation, the exhibited commodity is referred to as provisional commodity as well. A commodity that is a store commodity but is out of stock is also the provisional commodity.

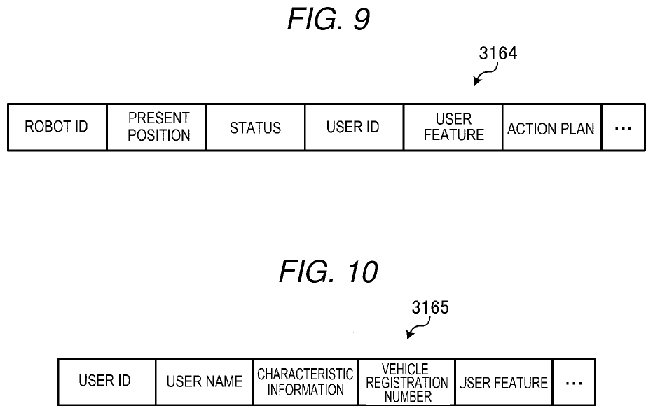

The robot management table 3164 is a data table for storing and managing information concerning the customer service robot 10. FIG. 9 is a diagram illustrating an example of a data configuration of the robot management table 3164. As illustrated in FIG. 9, the robot management table 3164 stores robot information such as a present position, a status, a user ID, a user feature, an action plan in correlation with a robot ID. The robot ID is an identifier capable of identifying each of the customer service robots 10.

Information indicating a present position of the customer service robot 10 is stored in an item of the present position. Information indicating a present state of the customer service robot 10 corresponding to the robot ID is stored in an item of the status. For example, information indicating a present operation mode of the customer service robot 10 is stored. For example, information indicating the remaining power of a battery loaded on the customer service robot 10 is stored.

A user ID of a customer being attended by the customer service robot 10, that is, a customer who checked in to the customer service robot 10 (hereinafter referred to as check-in user as well) is stored in an item of the user ID. Note that, as explained below, the customer service robot 10 is capable of operating even if the item of the user ID is empty.

Information indicating features in appearance of a customer who is checking in to the customer service robot 10 is stored in an item of the user feature. For example, an image obtained by imaging a face or a figure of the customer (hereinafter referred to as customer image as well) and a feature value indicating a feature of the face or the figure of the customer are stored in the item of the user feature. The user feature is used if the customer who is checking in is recognized from an image captured by the imaging unit 143. An action plan explained below generated by the customer service robot 10 is stored in an item of the action plan.

Note that the data configuration of the robot management table 3164 is not limited to the example illustrated in FIG. 9. For example, the robot management table 3164 may store, in correlation with the robot ID, as user setting, changed content of the customer service robot 10 changed by personalize processing explained below. The robot management table 3164 may store, in correlation with the robot ID, an image, a video, voice, and the like acquired by the customer service robot 10 corresponding to the robot ID together with an acquisition date and time.

The user management table 3165 is a data table for storing and managing information concerning a customer. FIG. 10 is a diagram illustrating an example of a data configuration of the user management table 3165. As illustrated in FIG. 10, the user management table 3165 stores user information such as a user name, characteristic information, a vehicle registration number, and user setting in correlation with a user ID. The user ID is an example of an identifier capable of identifying each of customers.

Information indicating a name of the customer is stored in an item of the user name. Information indicating characteristics of the customer corresponding to the user ID is stored in an item of the characteristic information. For example, the characteristic information includes information indicating sex, age, a taste, and the like of the customer. The information indicating the taste may be information set by the customer himself or herself or may be information derived from a purchase history, a search history, and the like of the customer. In the latter case, for example, the control unit 314 may be configured to extract a purchase history of the customer corresponding to the user ID from the transaction management table 3166 or the like explained below and estimate a taste of the customer based on the extracted purchase history. For example, the control unit 314 may acquire a purchase history and a search history correlated with the user ID from an external system and estimate a taste of the customer based on acquired information. Note that a method of estimating a taste does not particularly matter. A publicly-known technique can be used.

A vehicle registration number of a vehicle owned by the customer is stored in an item of the vehicle registration number. The vehicle registration number is used to acquire entering time of the relevant vehicle from the parking lot system 40. The customer service support system 1 informs, for example, based on the entering time of the vehicle of the customer, a parking time and a parking fee to the customer being attended. The vehicle registration number is used to acquire a parking position of the relevant vehicle from the parking lot system 40. The customer service support system 1 transports a commodity purchased by the customer to the parking position, for example, according to an instruction of the customer.

The same content as the user information stored in the robot management table 3164 explained above is stored in an item of the user feature.

Note that the data configuration of the user management table 3165 is not limited to the example illustrated in FIG. 10. For example, the user management table 3165 may include, in correlation with the user ID, a terminal ID, address information, and the like of a terminal (the customer terminal 50) used by the customer. In order to perform face authentication for the customer, the user management table 3165 may store, in correlation with the user ID, a face image obtained by imaging the face of the customer and a feature value indicating a feature of the face.

The user management table 3165 may store, in correlation with the user ID, information capable of specifying a delivery destination of a commodity such as an address of the customer. The user management 3165 may table store settlement information in correlation with the user ID. The settlement information is information such as an account for using an electronic settlement service for which the customer has a contract in advance. The electronic settlement service includes code settlement, electronic money settlement, and credit settlement. If the electronic settlement service is the credit settlement, the settlement information may be a number of a credit card owned by the customer.

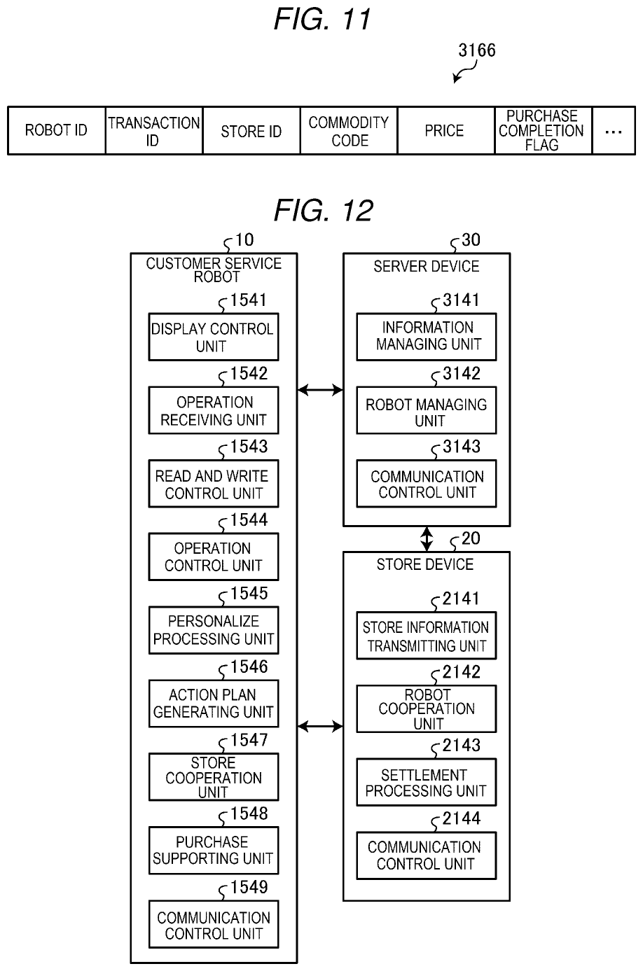

The transaction management table 3166 is a data table for storing and managing information concerning a transaction performed via the customer service robot 10. FIG. 11 is a diagram illustrating an example of a data configuration of the transaction management table 3166. As illustrated in FIG. 11, the transaction management table 3166 stores transaction information such as a store ID, a commodity code, a price, and a purchase completion flag in correlation with a robot ID and a transaction ID.

The transaction ID is an identifier capable of identifying each of transactions performed by the customer service robot 10 corresponding to the robot ID. As the transaction ID, a specific transaction ID is issued by the customer service robot 10 every time check-in of a customer is performed and the same transaction ID is continuously used until checkout operation for instructing a use end of the customer service robot 10 (or a customer service end by the customer service robot 10) is performed by the customer.

Note that, in this embodiment, each of the customer service robots 10 issues a transaction ID. However, not only this, but the server device 30 may issue a transaction ID. In this case, the control unit 314 of the server device 30 monitors statuses of the customer service robots 10 based on the robot management table 3164 and, if detecting the customer service robot 10, the status of which was switched to the customer service mode, issues a transaction ID to the customer service robot 10. By notifying the issued transaction ID to the customer service robot 10 corresponding to the transaction ID, the control unit 314 of the server device 30 can cause the customer service robot 10 to use the same transaction ID while the customer service mode of the customer service robot 10 continues.

A store ID, a commodity code, and a price relating to a commodity registered using the customer service robot 10 corresponding to the robot ID are registered in items of the store ID, the commodity code, and the price. Information indicating whether settlement (checkout) for the commodity corresponding to the commodity code was completed is stored in an item of the purchase completion flag.

Note that the data configuration of the transaction management table 3166 is not limited to the example illustrated in FIG. 11. For example, the transaction management table 3166 may store, in correlation with the robot ID, a user ID of a check-in user who checked in to the customer service robot 10 corresponding to the robot ID. The transaction management table 3166 may store, in correlation with the commodity code, information indicating whether the commodity corresponding to the commodity code is a store commodity or a provisional commodity. The transaction management table 3166 may store, in correlation with the commodity code, a date and time when registration or settlement of the commodity corresponding to the commodity code was performed.

It is assumed that the transaction management table 3166 is updated every time registration or settlement is performed in each of the customer service robots 10. Note that, in data stored in the transaction management table 3166, according to an instruction of a customer service end or the like designating a transaction ID notified from the customer service robot 10, data of the robot ID corresponding to the transaction ID and the transaction ID may be cleared or may be continuously retained. In the latter case, the data stored in the transaction management table 3166 can be treated as purchase histories of customers who used the commercial facility.

### (Functional Configuration of the Customer Service Support System)

Subsequently, functional configurations of the customer service robot 10, the store device 20, and the server device 30 explained above are explained. FIG. 12 is a functional block diagram illustrating an example of functional configurations of the customer service robot, the store device, and the server device. First, the server device 30 is explained.

### (Functional Configuration of the Server Device)

The CPU 311 operates according to a program stored in the ROM 312 or the storage unit 316, whereby the control unit 314 of the server device 30 functions as an information managing unit 3141, a robot managing unit 3142, and a communication control unit 3143. Note that a part or all of the functions may be implemented by hardware such as dedicated circuits.

The information managing unit 3141 cooperates with each of the customer service robot 10, the store device 20, and the parking lot system 40 to update the various data tables stored in the storage unit 316. For example, the information managing unit 3141 acquires information relating to the various data tables from each of the customer service robot 10, the store device 20, and the parking lot system 40 and updates the various data tables based on the acquired information.

A method of the information does not acquiring particularly matter. Various methods can be used as the method. For example, the information managing unit 3141 may acquire the information with a push type for passively acquiring the information transmitted from each of the customer service robot 10, the store device 20, and the parking lot system 40. The information managing unit 3141 may acquire the information with a pull type for actively acquiring the information by, for example, requesting each of the customer service robot 10, the store device 20, and the parking lot system 40 to provide information.

For example, if acquiring information concerning a status from the store device 20, the information managing unit 3141 updates the status relating to the store ID of the store device 20 stored in the store management table 3162.

For example, if acquiring information concerning position information, a status, and an action plan from the customer service robot 10, the information managing unit 3141 updates relevant data entry in the robot management table 3164 stored in correlation with the robot ID of the customer service robot 10. If acquiring a user ID and user setting of a customer being attended from the customer service robot 10, the information managing unit 3141 updates relevant data entry in the user management table 3165 stored in correlation with the user ID. For example, if acquiring information concerning a transaction from the customer service robot 10 together with a transaction ID, the information managing unit 3141 performs addition or deletion of a data entry, update of a purchase complete flag, and the like on the transaction management table 3166 based on the robot ID of the customer service robot 10 and the transaction ID.

Note that, in this embodiment, it is assumed that static information such as the user ID, the user name, the characteristic information, and the vehicle registration number among the user information stored in the user management table 3165 is registered in advance. However, not only this, but, for example, registration processing (hereinafter referred to as member registration as well) of a new user of the customer service support system 1 may be performed via the customer service robot 10 and the customer terminal 50. In this case, the user management table 3165 adds user information of the new user acquired from the customer service robot 10 or the customer terminal 50 to the user management table 3165.

The information managing unit 3141 provides the map information 3161 and the various data tables stored in the storage unit 316 to be referable from each of the customer service robot 10 and the store device 20. A method of providing data does not particularly matter. For example, the information managing unit 3141 provides the map information 3161 and the various data tables with a technique such as file sharing to be referable from each of the customer service robots 10. For example, the information managing unit 3141 extracts relevant data entry from the various data tables and provides the data entry to the customer service robot 10 at a request source according to a query including a robot ID, a user ID, a store ID, and the like as keys.

The robot managing unit 3142 collectively manages an operation of the customer service robot 10 in the commercial facility based on position information, a status, and the like of the customer service robot 10. For example, if the customer service robot 10 in a standby state (a standby mode) that does not perform a customer service is present, the robot managing unit 3142 instructs the customer service robot 10 in the standby state to move to a moving destination or the like. As an example, the robot managing unit 3142 instructs, based on positions of the customer service robots 10, the customer service robot 10 in the standby state to move to an entrance of the commercial facility, an area where a relatively small number of customer service robots 10 are present, or the like.

The communication control unit 3143 controls various kinds of communication between the server device 30 and the customer service robot 10. The communication control unit 3143 controls various kinds of communication between the server device 30 and the store device 20.

### (Functional Configuration of the Store Device)

The CPU 211 operates according to a program stored in the ROM 212 or the storage unit 219, whereby the control unit 214 of the store device 20 functions as a store information transmitting unit 2141, a robot cooperation unit 2142, a settlement processing unit 2143, and a communication control unit 2144. Note that a part or all of the functions may be implemented by hardware such as dedicated circuits.

The store information transmitting unit 2141 transmits, to the server device 30, store information concerning the store. For example, the store information transmitting unit 2141 transmits information indicating a congestion state of the store and a state of store opening and closing and the like to the server device 30 together with the store ID of the store. The congestion state of the store may be derived based on, for example, the number of customers visiting the store (customer service robots 10) per unit time. The congestion state of the store may be derived based on, for example, the number of customers included in images captured by monitoring cameras provided in the store. The store information transmitting unit 2141 may transmit a keyword relating to the store input by a store clerk or the like to the server device 30 together with the store ID of the store.

The robot cooperation unit 2142 establishes communication with the customer service robot 10 at an access source to implement cooperation with the customer service robot 10. The robot cooperation unit 2142 provides a commodity master or the like acquired from the server device 30 by the store device 20 to the cooperating customer service robot 10 to be referable by the customer service robot 10.

The robot cooperation unit 2142 cooperates with the customer service robot 10 to control light emission of electronic shelf labels provided in the store. For example, if receiving a light emission instruction designating a type of a commodity or the commodity from the customer service robot 10, the robot cooperation unit 2142 causes an electronic shelf label in a display position of the commodity of the type or the commodity designated by the light emission instruction to emit light.

The settlement processing unit 2143 executes settlement processing for a commodity sold in the store. For example, the settlement processing unit 2143 executes processing for calculating a total amount based on commodity codes and the numbers of items of commodities registered by a registration device provided in the store or the customer service robot 10 and settling the total amount with a payment amount of the customer. If the settlement processing was completed, the settlement processing unit 2143 causes a not-illustrated printer to dispense a receipt on which details of the settlement processing are printed. Note that, in this embodiment, it is assumed that the settlement processing unit 2143 performs settlement processing by cash. However, a settlement method adaptable by the settlement processing unit 2143 is not limited to this.

The communication control unit 2144 controls various kinds of communication between the store device 20 and the customer service robot 10 via the network N, short-range wireless communication, or the like. The communication control unit 2144 controls various kinds of communication between the store device 20 and the server device 30.

### (Functional Configuration of the Customer Service Robot)

The CPU 151 operates according to a program stored in the ROM 152 or the storage unit 161, whereby the control unit 154 of the customer service robot 10 functions as a display control unit 1541, an operation receiving unit 1542, a read and write control unit 1543, an operation control unit 1544, a personalize processing unit 1545, an action plan generating unit 1546, a store cooperation unit 1547, a purchase supporting unit 1548, and a communication control unit 1549. Note that a part or all of the functions may be implemented by hardware such as dedicated circuits.

The display control unit 1541 causes the display unit 155 to display various kinds of information. Specifically, the display control unit 1541 cooperates with the functions of the customer service robot 10 to cause the rear display unit 115 and the front display unit 132 to display various screens (GUIs: Graphical User Interfaces). Screen examples displayed by the display control unit 1541 are explained below.

The operation receiving unit 1542 receives user operation via the operation unit 156. For example, the operation receiving unit 1542 receives operation for the rear display unit 115 and the front display unit 132. The operation receiving unit 1542 receives operation for the stop button 142. The operation receiving unit 1542 receives utterance of a customer via the sound collecting unit 144 such as a wake word. The operation receiving unit 1542 receives an operation instruction by the customer terminal 50 and an operation instruction by a remote controller device.

The read and write control unit 1543 reads information via the imaging unit 143, the reader writer unit 157, and the like. For example, if a code symbol such as a barcode or a two-dimensional code is imaged by the imaging unit 143, the read and write control unit 1543 decodes the code symbol to read information (for example, a commodity code) stored in the code symbol. For example, the read and write control unit 1543 controls the reader writer unit 157 to read information (for example, a commodity code) stored in a wireless tag attached to a commodity or the like. For example, the read and write control unit 1543 controls the reader writer unit 157 to write information in the wireless tag.

The operation control unit 1544 collectively controls an operation of the customer service robot 10. Specifically, the operation control unit 1544 controls the driving unit 121 and causes, based on an image captured by the imaging unit 143 and sensing results of the various sensor units 158, the customer service robot 10 to travel along a moving route (hereinafter referred to as touring route or touring order as well) generated by the action plan generating unit 1546 explained below to implement autonomous traveling of the customer service robot 10. Note that the operation control unit 1544 is an example of the movement control unit in the present disclosure.

The operation control unit 1544 instructs the front imaging unit 1431 to capture a customer image if a user checks in. The operation control unit 1544 extracts user features out of the customer image and causes the user management table 3165 stored by the server device 30 to store the user features.

The operation control unit 1544 switches an operation mode of the customer service robot 10 according to a state and the like of the customer service robot 10. The customer service robot 10 in this embodiment roughly includes three operation modes of a standby mode, a customer service mode, and an after-store closing mode. The customer service robot 10 includes a leading mode and a following mode as operation modes at the time of the customer service mode.

The standby mode is an operation mode at the time of a standby state in which a customer service is not performed. The customer service mode is an operation mode for performing a customer service. The leading mode is an operation mode for leading a customer to a moving destination such as a store. The following mode is an operation mode for moving following the customer. The after-store closing mode is an operation mode for performing a job other than the customer service, for example, after closing of the commercial facility.

Under the customer service mode, the operation control unit 1544 enables the personalize processing unit 1545, the action plan generating unit 1546, the store cooperation unit 1547, the purchase supporting unit 1548, and the communication control unit 1549 and performs action support for the customer.

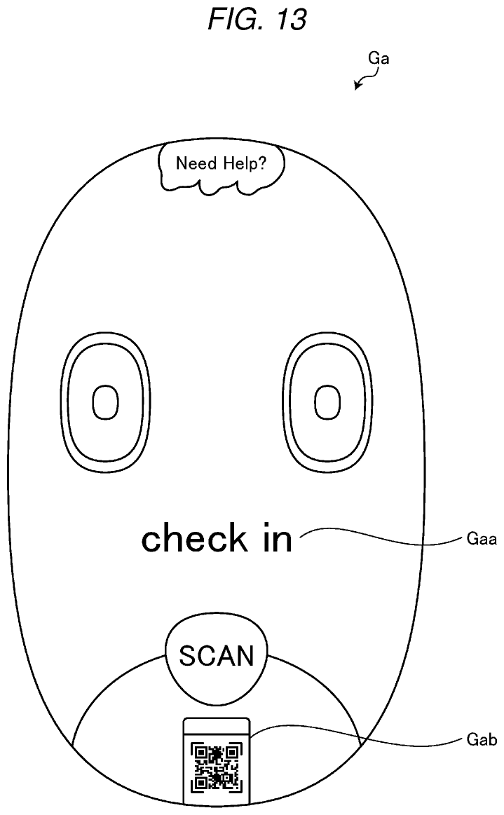

In the standby mode, the operation control unit 1544 causes the front display unit 132 to display a check-in screen for starting use of the customer service robot 10. For example, in the standby mode, the operation control unit 1544 causes the front display unit 132 to display, for example, a check-in screen Ga (see FIG. 13). Details of the check-in screen Ga are explained below.

Note that, during the standby mode, the operation control unit 1544 may cause the rear display unit 115 to display a message for informing that check-in is possible, an advertisement screen of the commercial facility, and the like. The operation control unit 1544 may cause the voice output unit 145 to output voice for urging check-in operation.

During the standby mode, the operation control unit 1544 may cause the customer service robot 10 to stop in a predetermined position, cause the customer service robot 10 to travel on a predetermined route, or may cause the customer service robot 10 to travel according to an instruction from the server device 30. Note that it is assumed that, if causing the customer service robot 10 to travel at the time of the standby mode, the operation control unit 1544 causes the customer service robot 10 to stop on condition that the operation control unit 1544 detected, via the sensor unit 158 or the sound collecting unit 144, presence of a customer around the customer service robot 10 or voice for calling to stop by the customer.

If the customer has meal while touring stores, the operation control unit 1544 causes the customer service robot 10 to shift to the standby mode. At this time, for example, the operation control unit 1544 may close a lockable door member provided in an upper part of the placing table 112 and protect commodities and luggage placed on the placing table 112 during the standby mode.

If the customer service robot 10 shifted to the leading mode, the operation control unit 1544 causes the customer service robot 10 to move to a destination store based on an action plan generated by the action plan generating unit 1546 explained below. Specifically, the operation control unit 1544 causes the customer service robot 10 to move in the order of destination stores specified in the action plan. The operation control unit 1544 causes the customer service robot 10 to travel at speed corresponding to a moving time between stores specified in the action plan.

In the leading mode, the operation control unit 1544 causes the customer service robot 10 to move the front of a checked-in customer while keeping a predetermined distance to the customer to guide the customer to a destination store. Specifically, the operation control unit 1544 specifies, based on a customer image stored at the check-in time, a person matching user features, that is, a check-in user out of an image captured by the rear imaging unit 1432. The operation control unit 1544 causes the customer service robot 10 to travel in front of the person toward the destination store while keeping a predetermined distance to the specified customer. At this time, the operation control unit 1544 causes the rear display unit 115 to display a screen for informing that the customer is guided to the destination store (hereinafter referred to as guidance screen as well) to urge the customer to move following the customer service robot 10.

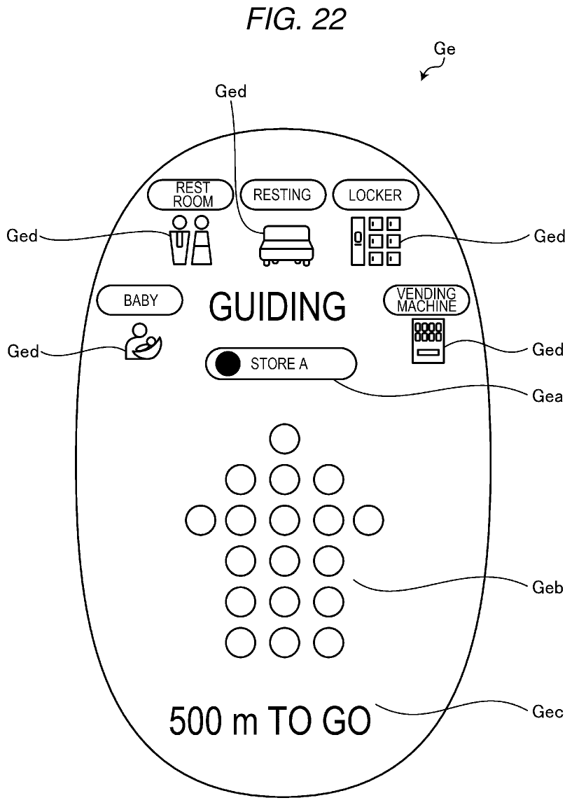

The operation control unit 1544 causes the display control unit 1541 to display a guidance screen Ge (see FIG. 22) on the rear display unit 115. Details of the guidance screen Ge are explained below. Note that the functional units of the customer service robot 10 causes the display control unit 1541 to display various screens on the front display unit 132 or the rear display unit 115. Since explanation is complicated, in the following explanation, it is simply described that “a target functional unit causes a target display unit to display various screens and various kinds of information”.

The operation control unit 1544 may perform guidance by voice output without being limited to the guidance by the screen display. For example, the operation control unit 1544 may output voice for informing movement to a destination store from the voice output unit 145 simultaneously with displaying the guidance screen Ge.

Note that it is assumed that a screen that the operation control unit 1544 causes the front display unit 132 to display during the movement of the customer service robot 10 does not particularly matter. For example, the operation control unit 1544 may cause the front display unit 132 to display an image simulating a face including eyes and a nose, which is the same as the check-in screen Ga explained above, while causing the customer service robot 10 to move. However, unlike the check-in screen Ga, it is preferable to also display information indicating that the customer is being guided.

Consequently, the customer can easily check a destination store, a distance to the store, and the like by viewing the guidance screen Ge displayed on the rear display unit 115 of the leading customer service robot 10. Since the customer can easily check a common space present in the vicinity during the movement to the destination store, the customer can move to the common space according to necessity.

Note that, if the customer moved away from the customer service robot 10 by moving to the common space or a rest room, the customer moves in a direction different from a moving direction of the customer service robot 10 and performs a motion outside the action plan in which the distance to the customer service robot 10 deviates from a specified value. If detecting the motion of the customer outside the action plan based on, for example, an image of the imaging unit 143, the operation control unit 1544 releases the leading mode and causes the customer service robot 10 to shift to the following mode for following the customer. If the customer entered the common space or the rest room, the operation control unit 1544 stays on standby at an entrance of the common space or the rest room until the customer comes out from the common space or the rest room. If the customer matching the user features came out from the common space or the rest room, the operation control unit 1544 causes the customer service robot 10 to shift to the leading mode and continues the guidance to the destination store. Note that the operation control unit 1544 causes the action plan generating unit 1546 explained below to reset a route for returning to the initial action plan from a position where the customer deviated from the action plan.

Similarly, if the customer moves to another store while being led, the operation control unit 1544 also releases the leading mode and causes the customer service robot 10 to shift to the following mode. In this case, the operation control unit 1544 continues the following mode until the customer leaves the store and, if detecting, based on position information or the like output by the positioning unit 159, that the customer left the store, causes the customer service robot 10 to shift to the leading mode and continues the guidance to the destination store. Note that, in this case, the operation control unit 1544 may cooperate with the action plan generating unit 1546 and update the action plan, for example, change touring order of the destination store.

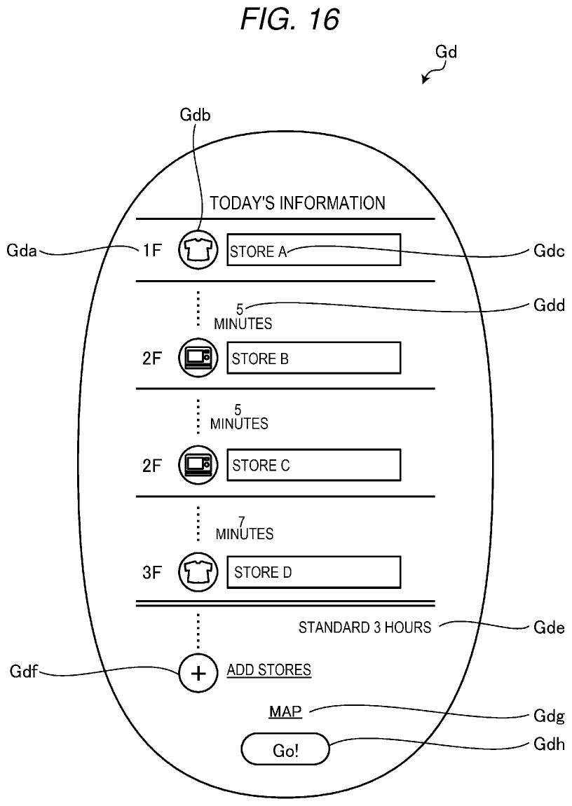

The operation control unit 1544 is capable of receiving operation of the customer even while the customer service robot 10 is operating in the leading mode. For example, if receiving operation of the stop button 142 during the movement of the customer service robot 10, the operation control unit 1544 causes the customer service robot 10 to stop the movement. For example, if receiving operation for touching the rear display unit 115, operation for knocking the main body unit 11, calling operation such as a wake word, or the like, the operation control unit 1544 causes the customer service robot 10 to stop the movement. The operation control unit 1544 causes the rear display unit 115 to display a generated action plan screen Gd (see FIG. 16) or the like to enable various kinds of operation to be received. If receiving, from the customer, for example, an instruction to move to a common space if the customer service robot 10 is moving according to the set moving route, the operation control unit 1544 changes the action plan and leads the customer to the instructed common space. At that time, the action plan generating unit 1546 resets a moving route.

If, according to the movement by the leading mode, the present position of the customer service robot 10 entered an area of the destination store or an area in a predetermined range starting from the position of the destination store, the operation control unit 1544 determines that the customer service robot 10 reached the destination store. If determining that the customer service robot 10 reached the destination store, the operation control unit 1544 shifts the operation mode of the customer service robot 10 from the leading mode to the following mode.

Note that it is assumed that the range of the area relating to the determination for reaching the destination store can be optionally set. For example, the entire site of the store may be set as the area relating to the reaching determination. For example, if a specific store (restaurant) present in a food court is the destination store, the entire region of the food court may be set as the area relating to the reaching determination.

If the customer service robot 10 shifted to the following mode, the operation control unit 1544 performs control for causing the customer service robot 10 to move following the check-in user. Specifically, the operation control unit 1544 causes the customer service robot 10 to travel behind the customer while keeping a predetermined distance to the check-in user. Consequently, the operation control unit 1544 causes the customer service robot 10 to travel following the customer while the customer stays in the destination store.

Note that, if the customer service robot 10 shifted to the following mode, the operation control unit 1544 may inform the customer, with screen display or voice, that the customer service robot 10 shifted to the following mode. For example, if the customer service robot 10 shifted to the following mode, the operation control unit 1544 may direct the front side of the customer service robot 10 to the customer and cause the front display unit 132 or the voice output unit 145 to output information for informing the arrival at the destination store and information for informing a following operation such as “I will accompany you”. The operation control unit 1544 may cause the rear display unit 115 to display information for informing that the customer service robot 10 is operating in the following mode or may cause the rear display unit 115 to display other information. For example, the operation control unit 1544 may cause the rear display unit 115 to display information such as an advertisement concerning the destination store at which the customer service robot 10 arrived or publicity for urging use of the customer service robot 10.

If the customer service robot 10 arrived at a store specified in the action plan, the operation control unit 1544 tracks an elapsed time after the arrival at the store. If the tracked elapsed time approached or reached a staying time in the store specified in the action plan, the operation control unit 1544 informs the customer, via display or voice, that it is time to move to the next store.

The operation control unit 1544 may cooperate with the store device 20 to cause an electronic shelf label to emit light. For example, if a task for causing an electronic shelf label in a display position of a commodity of a specific type to emit light is set in the destination store at which the customer service robot 10 arrived, the operation control unit 1544 cooperates with the store device 20 to cause the electronic shelf label in the display position to emit light. At that point, by causing the electronic shelf label to emit light in a light emission color set by the personalize processing unit 1545 explained below, it is possible to easily identify an electronic shelf label that emits light according to setting of another customer attended by another customer service robot 10.

Specifically, the store cooperation unit 1547 retrieves a commodity corresponding to a type set in the task from the commodity master 3163 and specifies a display position of the commodity. The store cooperation unit 1547 cooperates with the store device 20 and performs control for causing an electronic shelf label disposed in the specified display position to emit light.

Consequently, if reaching the destination store according to the leading of the customer service robot 10, the customer can easily grasp a display position of a commodity that the customer intends to purchase. Therefore, the customer service robot 10 can efficiently perform purchase support for the commodity that the customer intends to purchase.

The personalize processing unit 1545 performs personalize processing for changing setting concerning the operation of the customer service robot 10 from an initial state according to operation of the check-in user. The personalize processing unit 1545 performs personalize processing for changing characteristic information of the user management table 3165 and setting stored in user setting.

It is assumed that changeable setting of the customer service robot 10 does not particularly matter if the changeable setting is within a range not hindering a basic operation of the customer service robot 10. For example, a light emission color of the light emitting unit 141, UI (for example, language setting corresponding to a mother tongue of a customer), voice (male voice or female voice) emitted by the customer service robot 10, and the like can be changed. For example, the light emission color of the light emitting unit 141 can be changed to a favorite color of the customer based on an attribute of the customer stored in the characteristic information of the user management table 3165 and taste information of the customer stored in the user setting. If the customer service robot 10 includes a voice assistant function, a wake word used in calling (starting) the voice assistant function can be changed. Various informing methods performed by the customer service robot 10, a settlement method, and the like can be set. Note that the setting of the initial state of the customer service robot 10 may be the same or may be different.

It is assumed that a method of changing setting does not particularly matter either and the setting can be changed by screen operation or voice operation. For example, after check-in operation, the personalize processing unit 1545 may cause the front display unit 132 to display a screen for checking whether to perform a setting change. In this case, if the setting change is instructed, the personalize processing unit 1545 causes the front display unit 132 to display a setting change screen showing changeable items (both of the screens are not illustrated). If setting content after the change is determined by operation of the customer, the personalize processing unit 1545 changes setting of the customer service robot 10 to the setting content after the change. Note that it is assumed that the setting change can be performed at any timing during the customer service mode.

If the setting change was performed, the personalize processing unit 1545 registers the setting content after the change in the user management table 3165 as user setting in correlation with a user ID of the check-in user.

Note that, if the check-in user is a member of the customer service support system 1, the personalize processing unit 1545 may read the user setting stored in correlation with the user ID of the check-in user from the user management table 3165 and change the setting of the customer service robot 10 based on the user setting.

As explained above, the customer service robot 10 changes the setting according to the operation of the customer to allow customization for each of customers. Consequently, the customer can easily identify the customer service robot 10 that attends the customer and the other customer service robots 10. The customer can perform shopping and the like using the customer service robot 10 customized according to preference of the customer.

Note that, in this embodiment, it is possible to perform the setting change irrespective of whether the check-in user is a member of the customer service support system 1. If the check-in user is a nonmember, the personalize processing unit 1545 reflects change content on the customer service robot 10 without registering the change content in the user management table 3165. If the check-in user is a nonmember, the personalize processing unit 1545 may limit the setting change to be unable to be performed.

The action plan generating unit 1546 executes processing for supporting an action of the customer in the commercial facility. Specifically, the action plan generating unit 1546 narrows down destinations while checking a store visiting purpose and conditions acquired from the customer to generate an action plan including stores to be visited and a moving route in the commercial facility and proposes the action plan to the customer. Note that the action plan generating unit 1546 is an example of the route setting unit in the present disclosure. An operation example of the action plan generating unit 1546 is explained in detail below (see FIGS. 14 to 21).

Specifically, if receiving operation for deciding destination stores, the action plan generating unit 1546 generates, based on position information of each of the destination stores, the present position of the customer service robot 10, and the map information 3161, an action plan indicating a route to the destination stores. The action plan generating unit 1546 causes the front display unit 132 to display the action plan screen Gd (see FIG. 16) representing the generated action plan. Details of the action plan screen Gd are explained below.

The action plan includes, for each of the destination stores, at least information for specifying touring order of the destination store. The action plan may include information indicating presence positions (for example, floor numbers) of the destination stores. The action plan may include distances among the destination stores, times required for movement, staying times in the destination stores, and a total time obtained by totaling the moving times and the staying times.

In this case, a time uniform in the stores may be set as the staying times. Staying times corresponding to the destination stores and types of the destination stores may be set as the staying times based on an average value or the like of staying times calculated in advance for each of the stores and each of the types of the stores. Further, in the case of a configuration in which an action history is recorded in correlation with the user ID of the check-in user, staying times in the destination stores may be extracted from an action history in the past and an average value or the like of the extracted staying times may be set as a staying time.

A method of determining touring order of the destination stores does not particularly matter and a publicly-known technique such as route search can be used. The action plan generating unit 1546 arrange the touring order as appropriate. For example, the action plan generating unit 1546 may arrange the destination stores in order of closeness from the present position. If a favorite commodity of the customer is present in a plurality of stores, a store at the shortest total moving distance may be selected to set the touring order. The action plan generating unit 1546 may arrange the destination stores in order for minimizing a waiting time taking into account congestion states and the like of the destination stores.

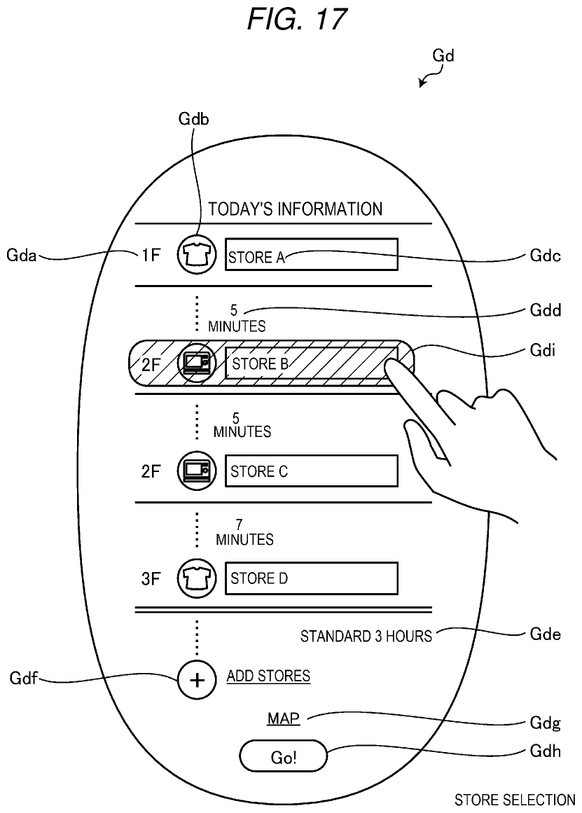

The action plan generating unit 1546 performs editing of the set moving route, the stores to be visited, and the staying times in the stores to be visited according to an instruction of the customer. In this case, the action plan generating unit 1546 functions as the route editing unit in the present disclosure. Specific examples of the editing of the moving route are explained below (see FIGS. 17 to 21).

The purchase supporting unit 1548 executes processing for supporting purchase of a commodity. For example, the purchase supporting unit 1548 executes, based on a commodity code read from a code symbol or a wireless tag, processing for registering a commodity corresponding to the commodity code as a purchase target. Specifically, if a commodity code is read by the read and write control unit 1543, the purchase supporting unit 1548 reads commodity information such as a commodity name and a price of a commodity corresponding to the commodity code from the commodity master 3163 and registers the commodity information in a data table (hereinafter referred to as local transaction management table as well) stored in the RAM 153 or the like. For example, the local transaction management table may the same data configuration as the transaction management table 3166 or may have a data configuration excluding the robot ID from the transaction management table 3166.

The purchase supporting unit 1548 executes, according to operation of the customer, settlement processing for a commodity registered in the local transaction management table. Specifically, the purchase supporting unit 1548 executes settlement processing for settling, with a payment amount of the customer, a total amount of commodities registered in the local transaction management table. If the settlement processing was completed, the purchase supporting unit 1548 gives a purchase completion flag in correlation with a commodity code of the settled commodity registered in the in the local transaction management table.

Note that it is assumed that a settlement method does not particularly matter and electronic settlement processing such as code settlement, credit settlement, and electronic money settlement can be performed. It is assumed that, if the customer service robot 10 includes a cash automatic adjustment machine, cash settlement can also be used.

If it assumed that, if the customer service robot 10 does not include a cash automatic adjustment machine, the purchase supporting unit 1548 transmits, via the network N, data for settlement to an external device capable of performing cash settlement to cause the device to perform the cash settlement. For example, the purchase supporting unit 1548 transmits data for settlement to an external device such as a POS terminal (an example of the store device 20) provided in a store or a checkout machine for cash settlement provided in the commercial facility to cause the external device to perform the cash settlement. In this case, the purchase supporting unit 1548 may determine, according to states of external devices, an external device to be set as a transmission destination. For example, the purchase supporting unit 1548 may determine, according to the balances of change included in the external devices and states of use of the external devices, an external device to be set as a transmission destination. Note that, if causing the external device to perform settlement, the purchase supporting unit 1548 preferably cooperates with the operation control unit 1544 to lead the customer to the external device at the settlement destination.

Note that the purchase supporting unit 1548 outputs, according to completion of the settlement processing, a receipt showing details of the transaction. For example, if the customer service robot 10 includes a printer or if a printer is connected to the customer service robot 10, the purchase supporting unit 1548 controls the printer to cause the printer to output a receipt.

The purchase supporting unit 1548 may output the receipt in a form of an electronic receipt. In this case, the purchase supporting unit 1548 may transmit the electronic receipt to the customer terminal 50 paired with the customer service robot 10. The purchase supporting unit 1548 may transmit the electronic receipt to an address described in the user management table 3165.

In this case, the purchase supporting unit 1548 may output a receipt every time settlement processing is performed or may output the receipt for each of the stores. In the latter case, the purchase supporting unit 1548 may output the receipt if the customer service robot 10 leaves the store. Further, if the touring of all the stores specified in the action plan was completed, the purchase supporting unit 1548 may collectively output receipts of settlement processing performed in the respective stores. Note that the customer can select output timing for the receipt. The output timing for the receipt may be able to be set by personalize processing. After updating the local transaction management table according to the registration of the commodity or the completion of the settlement processing, the purchase supporting unit 1548 transmits content of the updated local transaction management table to the server device 30 together with the robot ID of the customer service robot 10 and a transaction ID of the transaction to update the transaction management table 3166 of the server device 30. Consequently, the latest state of a transaction performed in each of the customer service robots 10 is reflected on the transaction management table 3166 of the server device 30. Note that, in this embodiment, the state of the transaction is stored in the transaction management tables of both of the customer service robot 10 and the server device 30. However, not only this, but the state of the transaction may be stored in one of the transaction management tables.

The purchase supporting unit 1548 includes a function for supporting the customer in selecting purchase candidate commodities. Specifically, the purchase supporting unit 1548 may include a recommendation function for selecting and presenting a commodity suitable for a taste of the customer as a purchase candidate.

For example, in a clothing store or the like, if a commodity to be set as a reference for recommendation is selected by reading a commodity code, the purchase supporting unit 1548 selects, based on information such as a size, a color, and design included in additional information of the commodity, a commodity set as a target of combination (substitution). The purchase supporting unit 1548 causes the front display unit 132 to display the selected commodity to present the selected commodity to the customer. It is possible to instruct, according to operation of the customer, to register the presented commodity as a purchase target or reject the presented commodity.

Note that a method of selecting a commodity does not particularly matter. A publicly-known technique concerning recommendation can be used. For example, the purchase supporting unit 1548 may select a commodity conforming to a purchase tendency and a taste of the customer based on a purchase history and the like stored in correlation with a user ID of the customer. In the example explained above, after the commodity set as the reference was selected, the purchase candidate commodities are selected based on the commodity. However, not only this, but the purchase candidate commodities may be selected from a commodity unselected state. In this embodiment, the purchase candidate commodities to be selected are store commodities in the store registered in the commodity master 3163 but are not limited to this.

In this embodiment, the purchase supporting unit 1548 limits a motion of the customer such that a commodity registered in the store cannot be taken out to the outside of the store until settlement is completed in the store. For example, the purchase supporting unit 1548 cooperates with the operation control unit 1544 to limit a motion such that the customer service robot 10 does not exit to the outside of the store until settlement is completed in all the registered store commodities. For example, if the customer service robot 10 is capable of moving to the outside of the store even if an unsettled store component is present, the purchase supporting unit 1548 stops, if the customer service robot 10 moves away from the store by a predetermined distance, movement of the customer service robot 10 and causes the front display unit 132 or the rear display unit 115 to display a screen for demanding settlement for the unsettled store commodities.

If an unsettled component is present among the registered store components, the purchase supporting unit 1548 may inform to that effect to call attention of a store clerk and the customer himself or herself. For example, by changing a color of the light emitting unit 141 or flashing the light emitting unit 141, the purchase supporting unit 1548 may inform that the unsettled store commodity is present. The purchase supporting unit 1548 may call attention of the store clerk by causing the rear display unit 115 to display states of registration and settlement of a commodity, for example, the number of registered items and the number of settled items of the commodity. The store clerk of the store or an employee of the commercial facility can easily grasp a state of a transaction such as presence or absence of an unsettled commodity by checking the display of the rear display unit 115.

Note that, if a provisional commodity was registered, the purchase supporting unit 1548 may enable settlement processing for the provisional commodity to be executed not only in the store but also after the customer left the store. Consequently, the customer can purchase a favorite commodity after comparing the provisional commodity and a similar commodity in another store.

The communication control unit 1549 controls communication between the customer service robot 10 and the server device 30 and communication between the customer service robot 10 and the store device 20. As explained below, if the customer service robot 10 moves among floors with different floor numbers using an elevator, the communication control unit 1549 controls communication with the elevator.

Note that all of exchanges of data performed among different devices are performed by functions of communication control units included in the devices. However, since explanation is complicated, in the following operation explanation, explanation relating to the communication control unit 1549, the communication control unit 3143, and the communication control unit 2144 is omitted.

Incidentally, the stores specified by the action plan sometimes include stores present in positions exceeding a movable range of the customer service robot 10. For example, movement across floors with different floor numbers is included in action patterns. In such a case, the operation control unit 1544 causes the customer service robot 10 to move to the floors with the different floor numbers using the elevator.

Specifically, the operation control unit 1544 performs wireless communication with the elevator to thereby call the elevator and designate a target floor number.

If an elevator is absent or the elevator cannot be used, the operation control unit 1544 demands support of the customer service robot 10 in the standby mode present in a floor with the target floor number. The operation control unit 1544 hands over an action pattern set in the customer service robot 10 to another customer service robot 10 to continue to support an action of the customer. The customer service robot 10 on the support demanding side guides the customer to a boarding gate of an escalator. The operation control unit 1544 causes the customer service robot 10 taking over the setting to an exit of the escalator with the target floor number. The customer moves to the target floor using the escalator. Thereafter, the customer service robot 10 present in the exit of the escalator continues the guidance for the customer.

At this time, setting information of the customer service robot 10 that attended the customer to that point, for example, all of the user ID, the user setting, the action plan, and the local transaction management table of the check-in user are handed over to the other customer service robot 10. Therefore, the customer does not need to perform the check-in operation again.

Note that, if an article such as a commodity is placed on the placing table 112 of the customer service robot 10 that performed the guidance to that point, the operation control unit 1544 may cause the front display unit 132 to display a screen for urging the customer to carry an article and move and place the article on a new customer service robot 10 or may cause the front display unit 132 to display a screen for instructing the customer to deposit the article in a reception counter or the like. In the latter case, if receiving an instruction for movement, the operation control unit 1544 conveys the article placed on the placing table 112 to the reception counter.

The handover of data between the customer service robots 10 is performed not only across floors with different floor numbers. For example, in floors with the same floor numbers, if floors to which the customer service robots 10 are movable are limited, data may be handed over among the customer service robots 10 that are in charge of the floors. If the customer service robots 10 in charge are different between the commercial facility and the parking lot, data may be handed over between the different customer service robots 10 if the customer moves between the commercial facility and the parking lot. Further, if a battery of the customer service robot 10 is exhausted and the customer service robot 10 cannot move in the entire course of an action pattern, data may be handed over to another customer service robot 10.

After the customer service robot 10 moved to all the stores specified in the action plan, the operation control unit 1544 clears the various data such as the user ID, the user setting, the action plan, and the local transaction management table stored in the customer service robot 10 and causes the customer service robot 10 to shift to the standby mode. For example, if receiving checkout operation for ending the use of the customer service robot 10 from the customer at any timing, the operation control unit 1544 clears the various data stored in the customer service robot 10 and causes the customer service robot 10 to shift to the standby mode.

The customer service robot 10, which shifted to the standby mode, moves to a predetermined position in the commercial facility according to control of the operation control unit 1544. As an example, after shifting to the standby mode, the customer service robot 10 moves to a charging area where the battery can be charged.

The customer service robot 10 in the standby mode may be configured to move to a designated position according to an instruction from the store device 20 or the server device 30. In this case, the number of movable customer service robots 10 is not limited to one. It is also possible to collectively move a plurality of customer service robots 10.

Incidentally, it is possible to cause the customer service robot 10 to convey commodities purchased in the stores by placing the commodities on the placing table 112 included in the customer service robot 10. On the other hand, depending on a form of a commodity or an intension of a customer, it is also assumed that the customer does not receive a purchased commodity on the site and receives the commodity at another opportunity or in another place. For example, if a store is a showroom store, since commodities in the store are exhibited articles, a real object of a commodity cannot be received on the site. For example, if carried luggage and other commodities are placed on the placing table 112 of the customer service robot 10, a commodity purchased anew sometimes cannot be placed on the placing table 112.

Therefore, the purchase supporting unit 1548 may cause the front display unit 132 to display a screen on which a method of receiving a commodity for which settlement processing was completed can be selected. For example, the purchase supporting unit 1548 causes the front display unit 132 to display a not-illustrated screen on which the receiving method can be selected. On the screen on which the receiving method can be selected, choices such as mailing, counter reception, locker reception, exit reception, and parking lot reception are displayed. The purchase supporting unit 1548 specifies the receiving method by acquiring a selection result of the customer. Subsequently, the purchase supporting unit 1548 requests the customer to designate detailed information corresponding to the selected receiving method. For example, if the mailing was selected, the purchase supporting unit 1548 instructs the customer to input information concerning a mailing destination. If the counter reception, the locker reception, or the exit reception was designated, the purchase supporting unit 1548 instructs the customer to designate a specific position of a counter, a specific position of a locker, a specific position of an exit, or the like. Further, if the parking lot reception was designated, the purchase supporting unit 1548 checks whether the parking lot reception may be performed in a parking position of an automobile of the customer acquired from the parking lot system 40.

As explained above, the customer service robot 10 in this embodiment can hand over, with a method desired by the customer, a commodity for which settlement was completed.

The customer service robot 10 operates in the after-store closing mode different from the operation modes explained above outside a business hour, for example, after a business end of the commercial facility. Specifically, if the present date and time reaches the outside of the business hour of the commercial facility, the operation control unit 1544 causes the customer service robot 10 to shift to the after-store closing mode.

The customer service robot 10 in the after-store closing mode performs an operation different from the operations in the standby mode and the customer service mode explained above. For example, the operation control unit 1544 causes the customer service robot 10 to travel on a predetermined route in the commercial facility and images a peripheral environment using the imaging unit 143 to perform a patrol job for the commercial facility and the stores.

The customer service robot 10 in the after-store closing mode may support an inventory job in a preset store. In this case, for example, while the customer service robot 10 is touring in the store, the operation control unit 1544 causes the reader writer unit 157 to operate to read commodity codes and individual item codes from wireless tags of commodities present in the store. The operation control unit 1544 totalizes the numbers of items of the commodities based on a reading result and, for example, transmits an inventory result to the store device 20.

### (Specific Example of Check-In Processing)

An operation example of check-in processing is explained with reference to FIG. 13. FIG. 13 is a diagram illustrating an example of the check-in screen displayed on the front display unit of the customer service robot at a check-in time.

An image simulating a face including eyes and a nose is displayed on the check-in screen Ga. A message Gaa for urging check-in operation of a customer is displayed on the check-in screen Ga.

A check-in operation method does not particularly matter. However, an operation method for a customer (hereinafter referred to as member as well), whose user information is registered in the user management table 3165, and an operation method for a nonmember, whose user information is unregistered in the user management table 3165, are preferably prepared. In this embodiment, operation for inputting a user ID to the customer service robot 10 is set as check-in operation for a member. Touch operation on the check-in screen Ga is set as check-in operation for a nonmember. Note that, as an example of the check-in screen Ga illustrated in FIG. 13, an example is explained in which an image Gab for informing presentation of a two-dimensional code, in which a user ID is registered, to the customer terminal 50 of the customer in order to urge the customer to input the user ID.

Note that the image Gab may include information for informing that the customer service robot 10 is caused to read a code symbol displayed on the customer terminal 50. If a code symbol for check-in is displayed on the check-in screen Ga, the image Gab may include information informing the code symbol and informing that the code symbol is read by the customer terminal 50. In the latter case, it is preferable to include, in the code symbol displayed on the check-in screen Ga, information for pairing the customer terminal 50 with the customer service robot 10 as explained below. In this case, the operation control unit 1544 may acquire the user ID from the paired customer terminal 50 to receive input of the user ID.

For example, if the two-dimensional code displayed on the customer terminal 50 is held over the front imaging unit 1431, the user ID is read from the two-dimensional code by the read and write control unit 1543. If receiving input of the user ID via the read and write control unit 1543, the operation control unit 1544 retrieves the input user ID from the user management table 3165 to determine whether the customer is a member. If the input user ID is registered in the user management table 3165, the operation control unit 1544 determines that check-in operation by the member was performed and shifts the operation mode of the customer service robot 10 from the standby mode to the customer service mode. Note that the operation control unit 1544 may issue a transaction ID if the operation mode is shifted to the customer service mode. The operation control unit 1544 acquires an image and a feature value of the customer, who performed the check-in operation, as user features from an image captured by the front imaging unit 1431 and stores the user features in the RAM 153 or the like in correlation with the input user ID. The operation control unit 1544 registers the present operation mode, the input user ID, and the user features in the robot management table 3164 in correlation with the robot ID of the customer service robot 10.

If receiving touch operation on the check-in screen Ga, the operation control unit 1544 determines that check-in operation was performed by the nonmember and shifts the operation mode of the customer service robot 10 from the standby mode to the customer service mode. In this case, the operation control unit 1544 locally stores user features of the customer, who performed the check-in operation, and registers the present operation mode and the user features in the robot management table 3164 in correlation with the robot ID of the customer service robot 10. In this case, the personalize processing unit 1545 may cause the front display unit 132 to display a screen for urging member registration.

Note that it is assumed that, even if the check-in operation by the touch operation was performed, during the customer service mode, it is possible to shift to a check-in state by the member by inputting the user ID at any timing.

It is assumed that the operation control unit 1544 is capable of establishing communication (pairing) by short-range wireless communication with the customer terminal 50 irrespective of whether a checked-in customer (hereinafter referred to as check-in user as well) is a member. In this case, for example, the operation control unit 1544 causes the front display unit 132 to display, in a form of a two-dimensional code, setting information for pairing with the customer service robot 10 and reads setting information of the customer terminal 50 via the read and write control unit 1543. If the customer service robot 10 was paired with the customer terminal 50, the operation control unit 1544 captures the position of the check-in user and the distance to the customer service robot 10 based on RSSI (reception signal intensity) or the like and transmits and receives various kinds of information. For example, the customer terminal 50 may be used as a remote controller device that controls the customer service robot 10.

A pairing target is not limited to the customer terminal 50 and may be a simpler beacon terminal. In this case, the beacon terminal may be rent out from the commercial facility or may be detachably provided in the customer service robot 10. If the customer service robot 10 was paired with the beacon terminal, the operation control unit 1544 captures the position of the check-in user and the distance to the customer service robot 10 based on RSSI (reception signal intensity) or the like and transmits and receives various kinds of information.

Note that, by imparting a remote controller function to the beacon terminal, the beacon terminal may be used as a remote controller device that controls the customer service robot 10.

### (Specific Examples of the Action Plan Setting)

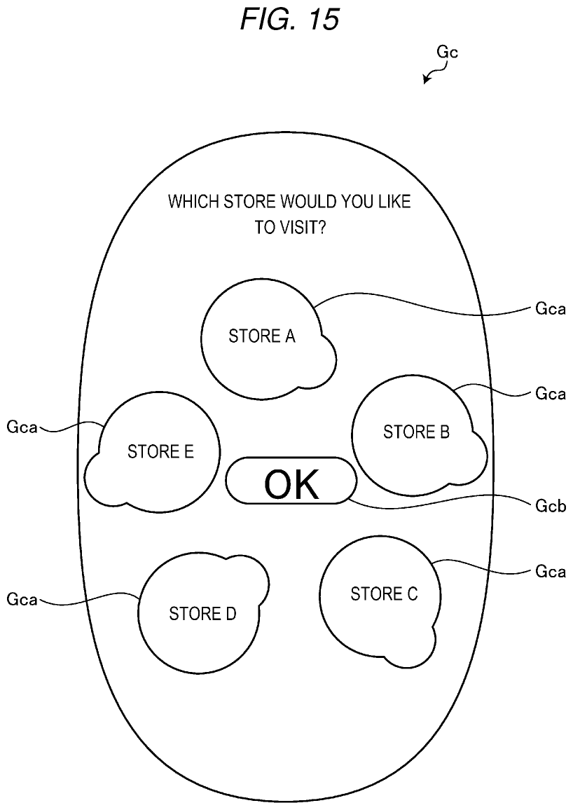

Specific examples of the action plan setting are explained with reference to FIGS. 14 to 16. FIG. 14 is a diagram illustrating an example of a screen displayed on the front display unit of the customer service robot if a customer instructs a store visiting purpose. FIG. 15 is a diagram illustrating an example of a screen displayed on the front display unit of the customer service robot if the customer selects a store that the customer desires to visit. FIG. 16 is a diagram illustrating an example of schematic information of a generated moving route displayed on the front display unit of the customer service robot.

The action plan generating unit 1546 causes the front display unit 132 to display a store visiting purpose check screen Gb illustrated in FIG. 14 in order to check a purpose of a customer. On the store visiting purpose check screen Gb, a plurality of choices Gba indicating types of purposes set based on the store types of the stores and the keywords registered in the store management table 3162. For example, as illustrated in FIG. 14, rough objectives such as “want to buy”, “want to play”, and “want to eat” are displayed as the choices Gba. For example, any one of the choices Gba can be selected. After any one of the choices Gba was selected, if the selection is decided by operation of an operation piece Gbb in the center, the action plan generating unit 1546 causes the front display unit 132 to display a store check screen Gc in order to further narrow down purposes of the selected choice Gba.

A plurality of choices Gca indicating stores where a purpose selected on the immediately preceding store visiting purpose check screen Gb can be achieved are displayed on the store check screen Gc. FIG. 15 is an example of the store check screen Gc and illustrates an example of a case in which the choice Gba of “want to buy” was selected from the store visiting purpose check screen Gb illustrated in FIG. 14.

As another example, types and the like of commodities that can be purchased in the commercial facility may be displayed in the choices Gca of the store check screen Gc. In this case, if a type of a commodity is selected via the choice Gca and the selection decided by operation of an operation piece Gcb, the action plan generating unit 1546 may further cause the front display unit 132 to display a new store check screen Gc in which a store name of a store that sells the commodity of the selected type is a choice. In this way, the action plan generating unit 1546 narrows down the purpose of the customer stepwise to determine a store set as a destination matching the purpose (hereinafter referred to as destination store as well).

Note that the number of times the narrow-down is performed using the store visiting purpose check screen Gb and the store check screen Gc does not particularly matter. For example, the number of times the narrow-down is performed may be different for each of purposes. In the example explained above, the destination store is selected at the final stage of the narrow-down. However, the number of selectable stores is not limited to one and may be two or more.

The action plan generating unit 1546 may automatically determine a destination store from conditions of a selected purpose. In this case, the action plan generating unit 1546 may determine one or a plurality of destination stores based on characteristic information, a purchase history, and the like stored in correlation with a user ID of a check-in user.

After a destination store was determined for a certain purpose on the store visiting purpose check screen Gb, it is also possible to determine a destination store relating to a different purpose by returning to the first or immediately preceding check screen Gb.

FIG. 16 is an example of the action plan screen Gd. Store names of destination stores specified in an action plan and order for touring the destination stores are displayed on the action plan screen Gd. In FIG. 16, an example is illustrated in which touring in the order of a store A, a store B, a store C, and a store D is displayed. In the example illustrated in FIG. 16, a floor number Gda of a destination store, a commodity icon Gdb indicating a representative commodity sold in the store, a store name Gdc, a time Gdd required for movement between stores, and a total required time Gde are also displayed.

The operator operating the customer service robot 10 can check destination stores and order of the destination stores by viewing the action plan screen Gd. On the action plan screen Gd, as explained below, the order of the destination stores can be changed and the destination stores can be deleted according to operation of the customer.

On the action plan screen Gd, a destination store can be also added according to operation of the customer. For example, if receiving operation of an operation piece Gdf, the action plan generating unit 1546 displays, on the front display unit 132, a screen on which a destination store can be added. For example, such a screen may be a screen on which store names capable of directly designating stores are displayed as a list or may be the store visiting purpose check screen explained above.

An operation piece Gdg for displaying a map of the commercial facility is provided on the action plan screen Gd. If receiving operation of the operation piece Gdg, the action plan generating unit 1546 causes, based on the map information 3161, the front display unit 132 to display a screen (not illustrated) showing positions of destination stores on the map of the commercial facility. The action plan generating unit 1546 may cause the front display unit 132 to display a map applied with processing for adding numbers indicating order of touring the positions of the destination stores and highlighting moving routes among the destination stores.

An operation piece Gdh for instructing to start movement to a destination store is provided on the action plan screen Gd. If the operation piece Gdh was operated, the operation control unit 1544 shifts the operation mode of the customer service robot 10 to the leading mode. Note that the operation control unit 1544 may issue a transaction ID at timing when the action plan is generated or timing when the start of movement to the destination store is instructed.

Note that, on the action plan screen Gd, by selecting a store name and the like of a displayed destination store, it is also possible to set processing content executed if the customer service robot 10 reaches the destination store. For example, processing for causing an electronic shelf label of a shelf, on which a commodity of a type selected on the store visiting purpose selection screen is displayed, to emit light if the customer service robot 10 arrives at the destination store can be set as a task. The task set for the destination store is executed by control of the operation control unit 1544 if the customer service robot 10 arrives at the destination store.

The task specifies processing requested from the customer and is executed at preset timing. For example, the task can be represented by a set of an execution condition and processing content. In the case of the example explained above, the execution condition is specified by a set of a “store name” of a store where the processing is executed and an “arrival time at the store” for specifying execution timing of the processing. In the processing content, for example, a command for instructing light emission of an electronic shelf label is set together with, for example, a commodity code representing the type of the commodity selected on the store visiting purpose selection screen. The processing content of the task set for the destination store is executed by the control of the operation control unit 1544 based on the execution condition of the task. Note that an execution condition and processing content that can be set as the task are not limited to this.

### (Action Plan Editing Function)

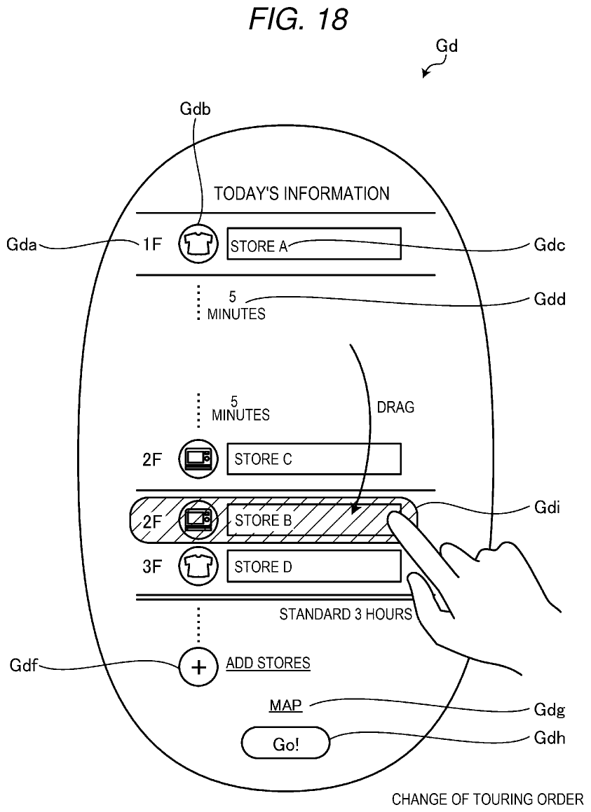

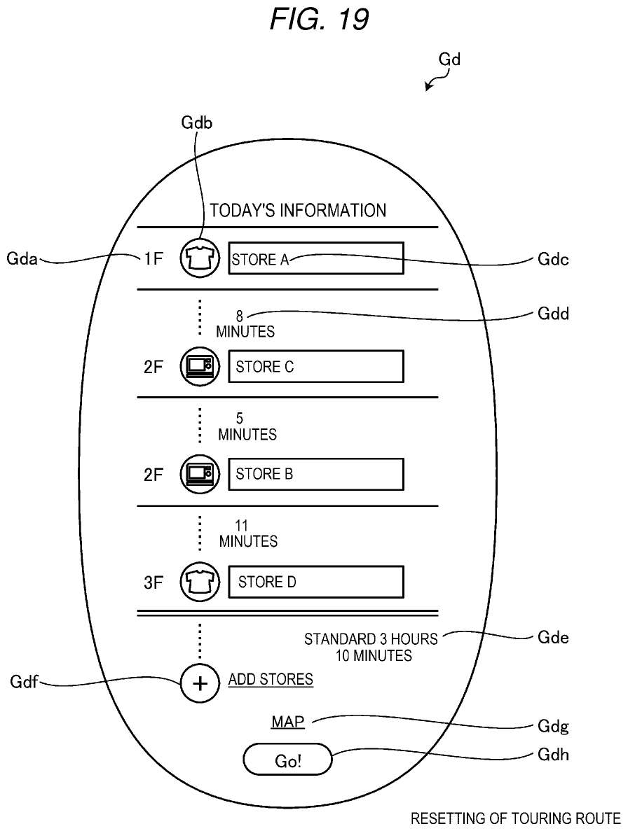

A specific method of changing proposed store touring order, which is an example of action plan editing is explained with reference to FIGS. 17 to 19. All of FIGS. 17 to 19 are diagrams for explaining the method of changing store touring order. FIG. 17 is a diagram illustrating a state in which, for example, a customer long-presses a store name Gdi of a store for which the customer desired to change touring order and selected a store (in this case, the store B). FIG. 18 is a diagram illustrating a state in which the touring order of the selected store B was moved to after the touring order of the store C. FIG. 19 is a diagram illustrating a state in which the action plan generating unit 1546 reset a touring route in the state in which the touring order was changed.

As illustrated in FIG. 17, if detecting that the store name Gdi was long-pressed, the action plan generating unit 1546 selects the store.

If the operation receiving unit 1542 detected operation for dragging the store name Gdi while keeping pressing the store name Gdi, the action plan generating unit 1546 changes the touring order of the store by moving the store name Gdi to a position to which the store name Gdi was dragged. In an example illustrated in FIG. 18, the position of the selected store B is changed to a position between the store C and the store D.

Further, as illustrated in FIG. 19, the action plan generating unit 1546 resets a touring route in a state in which the touring order was changed. As illustrated in FIG. 19, the time Gdd required for movement between stores and the total required time Gde are changed according to the resetting of the touring route.

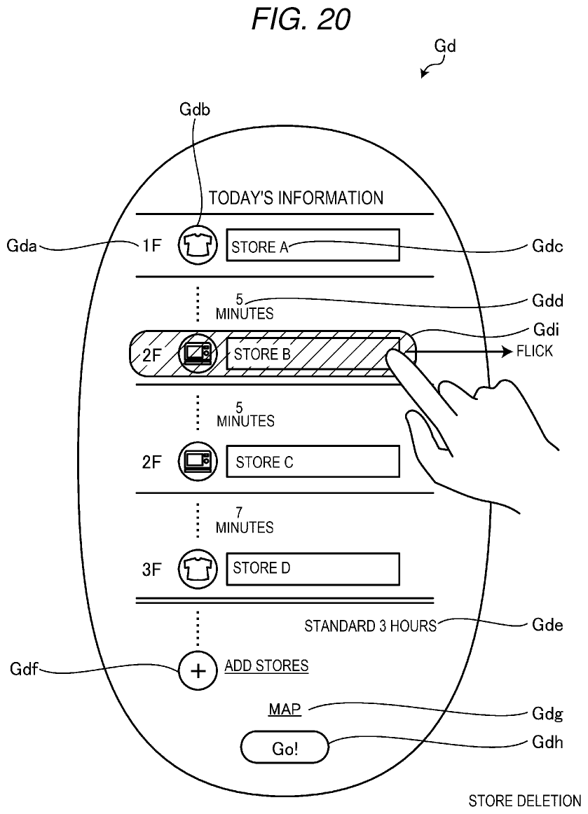

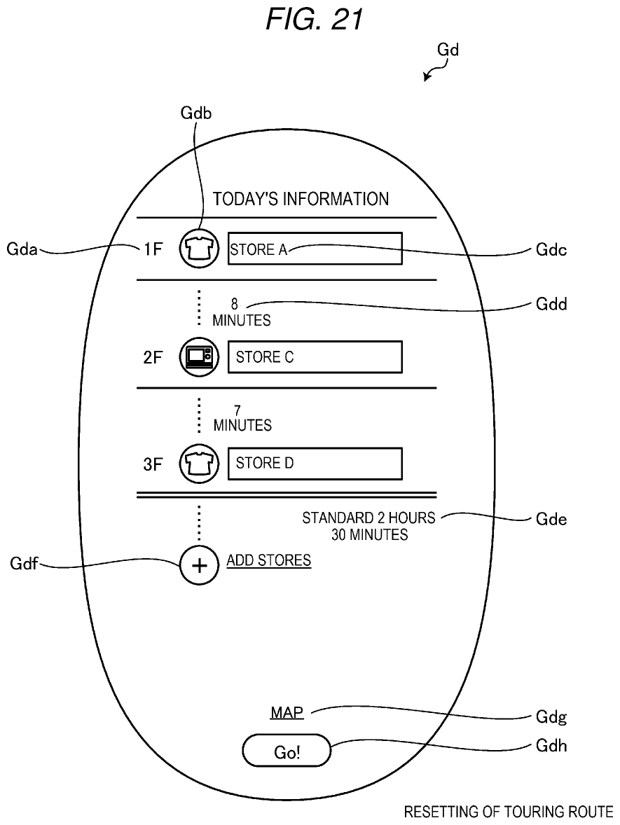

Subsequently, a specific method of deleting a proposed store, which is an example of action plan editing, is explained with reference to FIGS. 20 and 21. FIG. 20 is a diagram illustrating a state in which a store to be deleted was selected. FIG. 21 is a diagram illustrating a state in which the action plan generating unit 1546 reset a touring route in a state in which the store was deleted.

As illustrated in FIG. 20, for example, if detecting that the store name Gdi was long-pressed, the action plan generating unit 1546 selects the store (in this case, the store B).

Thereafter, if the operation receiving unit 1542 detected operation for flicking the store name Gdi while pressing the store name Gdi, the action plan generating unit 1546 deletes the store name Gdi.

Further, the action plan generating unit 1546 resets a touring route in a state in which the store B was deleted. As illustrated in FIG. 21, the time Gdd required for movement between stores and the total required time Gde are changed according to the resetting of the touring route.

Although not illustrated, if a staying time in the store is changed, for example, the staying time can be reset in a sub-window that pops up if the store name Gdi is short-pressed.

### (Example of a Guidance Screen Displayed on the Customer Service Robot During Movement)

Guidance information displayed by the customer service robot during movement is explained with reference to FIG. 22. FIG. 22 is a diagram illustrating an example of guidance information displayed on the rear display unit while the customer service robot is moving in the leading mode.

The display control unit 1541 causes, based on information acquired from the operation control unit 1544 and the action plan generating unit 1546 of the customer service robot 10, the rear display unit 115 of the customer service robot 10 to display a guidance screen Ge illustrated in FIG. 22.

A store name Gea (in this case, the store A) at a moving destination and a message indicating that the customer service robot 10 is guiding a customer are displayed on the guidance screen Ge. An arrow Geb indicating a direction in which the customer service robot 10 moves and a distance Gec to the store at the moving destination are displayed on the guidance screen Ge. Peripheral information Ged indicating common spaces present around the present position of the customer service robot 10 is displayed in an upper part of the guidance screen Ge. Positions where the peripheral information Ged is displayed in the screen correspond to directions in which the respective common spaces are present, for example, based on the present position and a moving method of the customer service robot 10. For example, the example illustrated in FIG. 22 indicates that a vending machine is present on the right side of a traveling direction of the customer service robot 10 and a baby resting room is present on the left side of the traveling direction of the customer service robot 10. FIG. 22 indicates that a rest room, a resting place, and a locker are present in the traveling direction of the customer service robot 10. Display positions of icons indicating these kinds of peripheral information Ged change according to the traveling direction of the customer service robot 10.

The operation control unit 1544 may perform guidance by voice output without being limited to the guidance by the screen display. For example, the operation control unit 1544 may output voice for guiding movement to a destination store simultaneously with displaying the guidance screen Ge.

Note that it is assumed that a screen that the operation control unit 1544 causes the front display unit 132 to display while the customer service robot 10 is moving in the leading mode does not particularly matter. For example, the operation control unit 1544 may cause the front display unit 132 to display an image simulating a face including eyes and a nose, which is the same as the image displayed on the check-in screen Ga explained above, while causing the customer service robot 10 to move. However, unlike on the check-in screen Ga, the operation control unit 1544 preferably also display information indicating that the customer service robot 10 is guiding a customer.

### (Examples of Various Screens Displayed on the Customer Service Robot During Shopping)

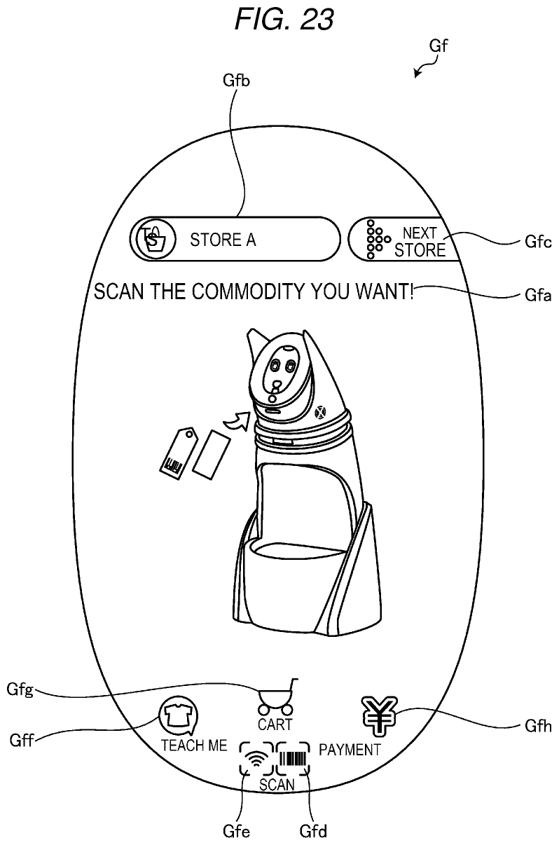

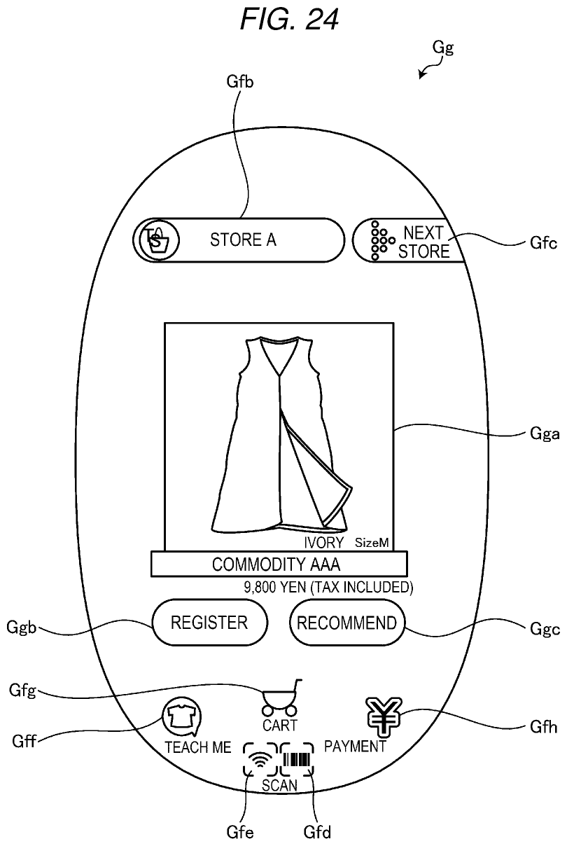

A specific operation example of the purchase supporting unit 1548 is explained with reference to FIGS. 23 and 24. FIG. 23 is a diagram illustrating an example of a basic operation screen displayed on the front display unit of the customer service robot. FIG. 24 is a diagram illustrating an example of a commodity screen.

If the customer service robot 10 arrived at a store and shifted to the following mode, the purchase supporting unit 1548 causes the front display unit 132 to display a basic operation screen Gf illustrated in FIG. 23 and stands by for operation of a customer.

A message Gfa for urging reading of a commodity and an image for explaining a reading method are displayed on the basic operation screen Gf. A store name Gfb of the store where the customer is staying and an operation piece Gfc explained below are provided in an upper part of the basic operation screen Gf.

Images Gfd and Gfe are displayed in a lower part of the basic operation screen Gf. The image Gfd is an icon indicating that it is possible to read a code symbol. The image Gfe is an icon indicating that it is possible to read a wireless tag.

Note that the images Gfd and Gfe may be operation pieces for enabling a hardware configuration relating to a reading function. For example, if one icon of the images Gfd and Gfe was touched, the purchase supporting unit 1548 may perform, according to the touched icon, control for enabling the imaging unit 143 or the reader writer unit 157.

Operation pieces Gff, Gfg, and Gfh are displayed on the basic operation screen Gf. The operation piece Gff is an operation piece for making an inquiry to a store clerk in the store. The operation piece Gfg is an operation piece for checking a registered commodity. If the operation piece Gfg was operated, a virtual basket screen (not illustrated) on which a commodity image, a commodity name, a price, and the like of a commodity registered at that point in time are displayed is displayed. The operation piece Gfh is an operation piece for instructing a start of settlement processing.

Note that, if the operation piece Gff was operated, the purchase supporting unit 1548 cooperates with the store device 20 to execute processing for requesting the store clerk of the store to attend the customer. For example, the store cooperation unit 1547 transmits the position of the customer service robot 10 and information for designating an inquiry target commodity to the store device 20 to request the store clerk of the store to attend the customer. In this case, the store device 20 notifies, for example, the position of the customer service robot 10 to a terminal carried by the store clerk of the store and urges the store clerk to attend the customer.

If receiving input of a commodity code by reading a code symbol or a wireless tag, the purchase supporting unit 1548 causes the front display unit 132 to display, for example, a commodity screen Gg illustrated in FIG. 24.

The commodity screen Gg includes the various operation pieces of the basic operation screen Gf explained above. A region Gga for displaying a commodity image is provided in the center of the commodity screen Gg. The purchase supporting unit 1548 reads commodity information corresponding to the input commodity code from the commodity master 3163 and causes the front display unit 132 to display a commodity image included in a read data entry in the region Gga. The purchase supporting unit 1548 executes commodity registration processing based on the read data entry.

In FIG. 24, a state in which a commodity AAA was read is illustrated. A commodity image indicating the exterior of the commodity AAA is displayed in the region Gga. A commodity name, a price, and the like of the commodity AAA are displayed near the region Gga.

An operation piece Ggb and an operation piece Ggc are provided on the commodity screen Gg. The operation piece Ggb is an operation piece for instructing commodity registration processing for a commodity displayed in the region Gga of the commodity screen Gg. The operation piece Ggc is an operation piece for instructing execution of a recommendation function. If receiving operation of the operation piece Ggb, the purchase supporting unit 1548 performs, based on an input commodity code, commodity registration processing (hereinafter referred to as commodity registration as well) for registering commodity information of a commodity corresponding to the commodity code in a local transaction management table. If receiving operation of the operation piece Ggc, the purchase supporting unit 1548 selects, based on, for example, additional information of the commodity displayed in the region Gga, from the commodity master 3163, a commodity to be combined (for example, coordinated) with the commodity AAA (hereinafter referred to as recommended commodity as well). The purchase supporting unit 1548 causes, based on a data entry of the selected commodity, the front display unit 132 to display the commodity screen Gg representing a commodity image and the like of the commodity.

Although not illustrated, an operation piece for instructing virtual try-on of the commodity displayed in the region Gga may be provided side by side with the operation pieces Ggb and Ggc. If receiving operation of the operation piece, the purchase supporting unit 1548 generates a synthesized image obtained by superimposing the commodity image of the commodity displayed in the region Gga on an image of the customer captured by the front imaging unit 1431. The purchase supporting unit 1548 causes the front display unit 132 to display the generated synthesized image in the region Gga or on another screen to implement the virtual try-on. Note that a publicly-known technique can be used for processing relating to the virtual try-on.

The purchase supporting unit 1548 proposes, based on the commodity selected by the customer, as a purchase candidate, a commodity that can be combined with the commodity. If the customer likes the proposed candidate commodity, the purchase supporting unit 1548 can register the candidate commodity as a purchaser target commodity.

### (Flow of Processing Performed by the Customer Service Robot)

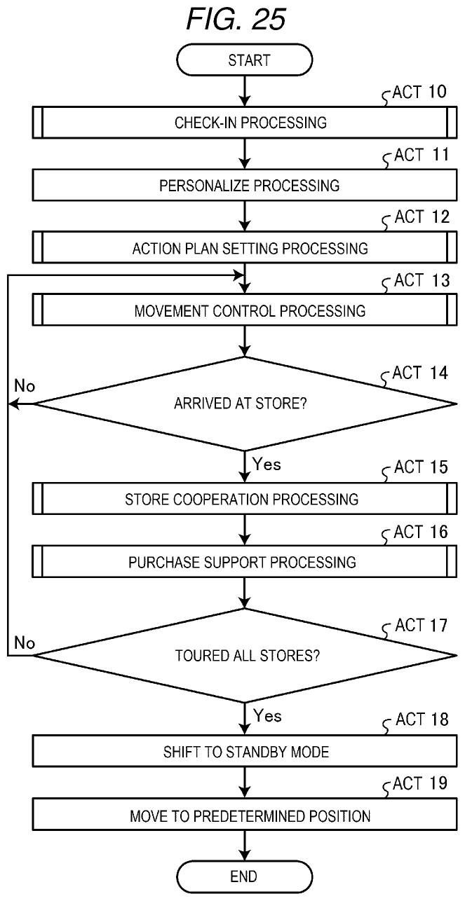

A flow of processing performed by the customer service robot 10 in the embodiment is explained with reference to FIG. 25. FIG. 25 is a flowchart illustrating an example of the flow of the processing performed by the customer service robot. Note that it is assumed that, as an initial state, the customer service robot 10 is in a state of the standby mode.

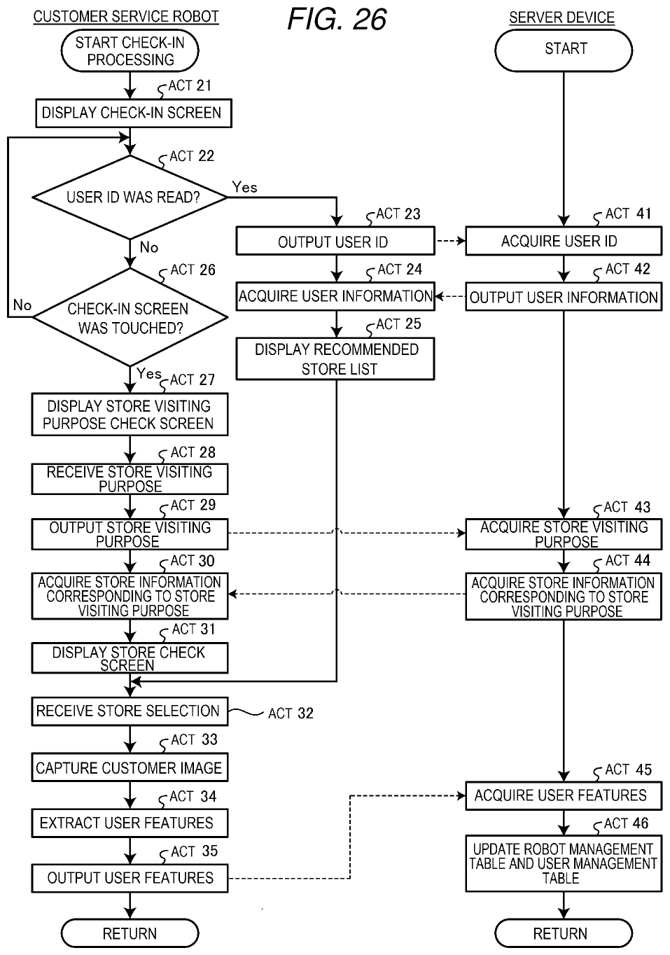

The operation control unit 1544 performs the check-in processing explained above (Act 10). A detailed flow of the check-in processing is explained below (see FIG. 26). Note that the customer service robot 10 shifts to the customer service mode according to the check-in processing.

The personalize processing unit 1545 performs the personalize processing explained above (Act 11). Specifically, if user setting of a check-in user was already registered, the personalize processing unit 1545 uses the registered user setting. On the other hand, if user setting of a check-in user was not registered yet, the personalize processing unit 1545 receives customize operation and performs various kinds of setting of the customer service robot 10.

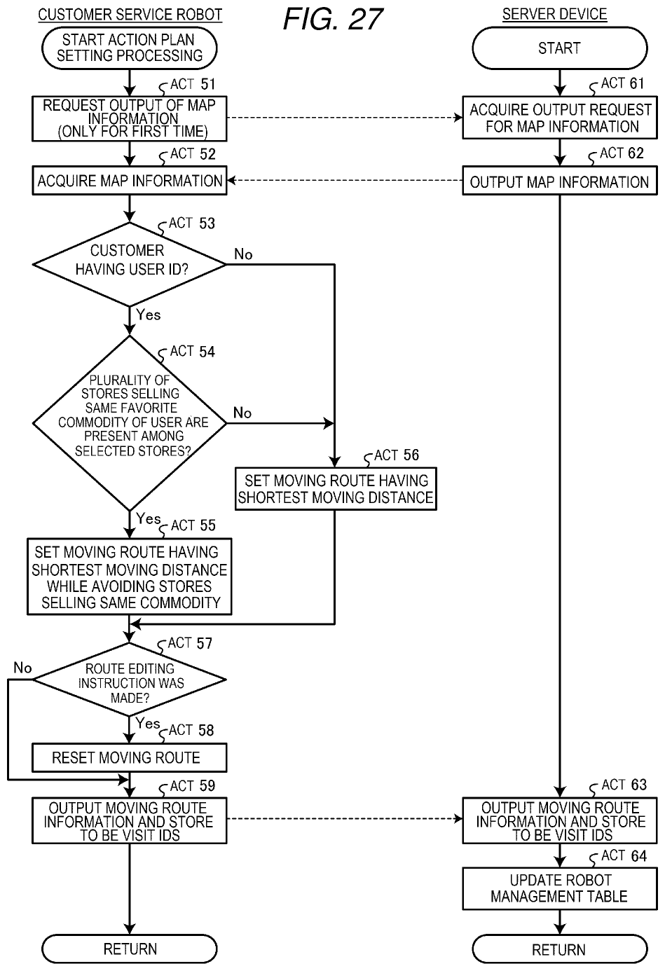

The action plan generating unit 1546 performs the action plan setting processing for setting the action plan explained above (Act 12). A detailed flow of the action plan setting processing is explained below (see FIG. 27).

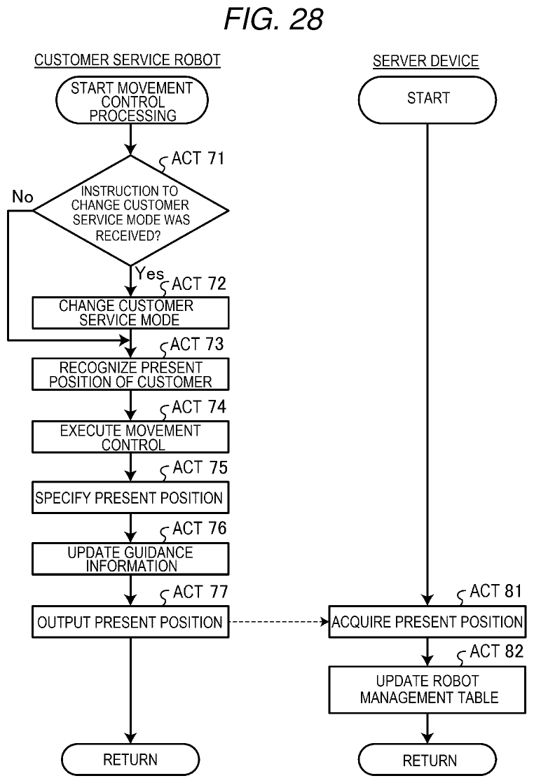

The operation control unit 1544 performs movement control processing for causing the customer service robot 10 to move according to the action plan (Act 13). A detailed flow of the movement control processing is explained below (see FIG. 28).

The operation control unit 1544 determines whether the customer service robot 10 arrived at a store that a customer visits next (Act 14). If it is determined that the customer service robot 10 arrived at the store, (Yes in Act 14), the processing proceeds to Act 15. On the other hand, if it is not determined that the customer service robot 10 arrived at the store (No in Act 14), the processing returns to Act 13.

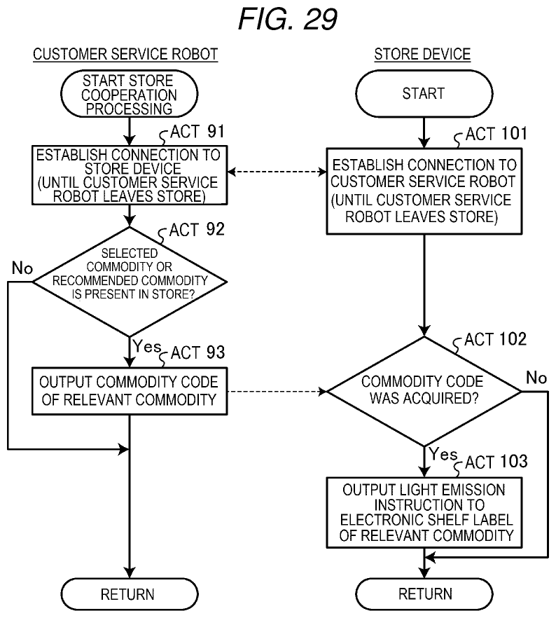

If it is determined in Act 14 that the customer service robot 10 arrived at the store, the store cooperation unit 1547 cooperates with the store device 20 of the store visited by the customer to thereby perform the store cooperation processing for, for example, causing an electronic shelf label to emit light as explained above (Act 15). A detailed flow of the store cooperation processing is explained below (see FIG. 29).

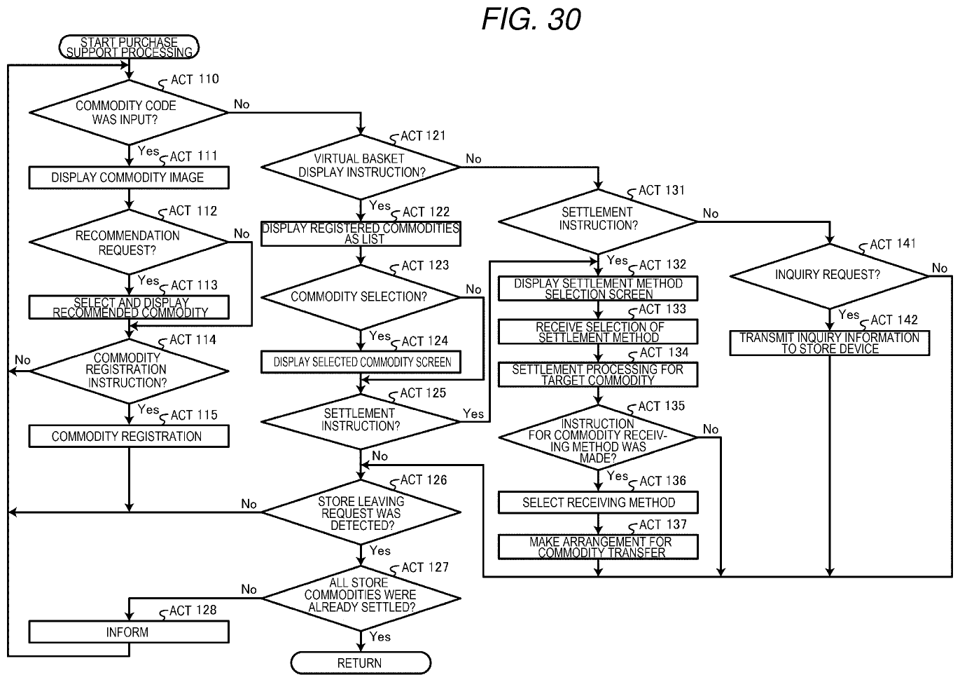

Subsequently, the purchase supporting unit 1548 performs purchase support processing for supporting purchase of a commodity (Act 16). A detailed flow of the purchase support processing is explained below (see FIG. 30).

The operation control unit 1544 refers to the action plan generated by the action plan generating unit 1546 to thereby determine whether the customer service robot 10 toured all the stores (Act 17). For example, if receiving check-out operation, the operation control unit 1544 determines that the customer service robot 10 toured all the stores. It is determined that the customer service robot 10 toured all the stores (Yes in Act 17), the processing proceeds to Act 18. On the other hand, if it is not determined that the customer service robot 10 toured all the stores (No in Act 17), the processing returns to Act 13.

If it is determined in Act 17 that the customer service robot 10 toured all the stores, the operation control unit 1544 clears the various data stored by the customer service robot 10 and causes the customer service robot 10 to shift to the standby mode (Act 18).

Subsequently, the operation control unit 1544 causes the customer service robot 10 to move to a predetermined position in the commercial facility. Note that the predetermined position may be the entrance of the commercial facility where the customer service robots 10 are collected or may be a charging area for charging the battery of the customer service robot 10 after use. Note that a store clerk may perform, with remote operation, operation for returning the customer service robot 10 to the predetermined position. Note that the remote operation for returning the customer service robot 10 to the predetermined position may be separately performed for the individual customer service robots 10 or may be operation for collectively returning a plurality of customer service robots 10 to the predetermined position. Thereafter, if arriving at the predetermined position, the customer service robot 10 ends the processing illustrated in FIG. 25.

### (Flow of the Check-In Processing Performed by the Customer Service Support System)

A flow of the check-in processing is explained with reference to FIG. 26. FIG. 26 is a flowchart illustrating an example of the flow of the check-in processing.

The customer service robot 10 cooperates with the server device 30 to thereby perform the check-in processing. First, a flow of processing performed by the customer service robot 10 is explained.

The operation control unit 1544 causes the front display unit 132 to display the check-in screen Ga (Act 21).

The read and write control unit 1543 determines whether a user ID of a check-in user was read (Act 22). If it is determined that the user ID was read (Yes in Act 22), the processing proceeds to Act 23. On the other hand, if it is not determined that the user ID was read (No in Act 22), the processing proceeds to Act 26.

If it is determined in Act 22 that the user ID was read, the action plan generating unit 1546 outputs the user ID received from the read and write control unit 1543 to the server device 30 (Act 23).

The action plan generating unit 1546 acquires, from the server device 30, user information of the user corresponding to the user ID (Act 24).

The action plan generating unit 1546 causes, based on a purchase history, a search history, and the like in the past of the user corresponding to the user ID, the front display unit 132 to display a not-illustrated recommended store list (Act 25). Thereafter, the processing proceeds to Act 32.

On the other hand, if it is not determined in Act 22 that the user ID was read, the action plan generating unit 1546 determines whether the operation receiving unit 1542 detected touch operation on the check-in screen Ga, that is, whether the check-in screen Ga was touched (Act 26). If it is determined that the check-in screen Ga was touched (Yes in Act 26), the processing proceeds to Act 27. On the other hand, if it is not determined that the check-in screen Ga was touched (No in Act 26), the processing returns to Act 22.

If it is determined in Act 26 that the check-in screen Ga was touched, the action plan generating unit 1546 causes the front display unit 132 to display the store visiting purpose check screen Gb (Act 27).

The action plan generating unit 1546 receives selection of a store visiting purpose on the store visiting purpose check screen Gb (Act 28).

Subsequently, the action plan generating unit 1546 outputs the selected store visiting purpose to the server device 30 (Act 29).

The action plan generating unit 1546 acquires, from the server device 30, store information corresponding to the store visiting purpose (Act 30).

The action plan generating unit 1546 causes the front display unit 132 to display the store check screen Gc (Act 31).

The action plan generating unit 1546 acquires a store selection result on the store check screen Gc detected by the operation receiving unit 1542 to thereby receive the store selection (Act 32).

The operation control unit 1544 causes the front imaging unit 1431 to capture a customer image (Act 33).

The operation control unit 1544 extracts user features from the customer image (Act 34).

The operation control unit 1544 outputs the user features to the server device 30 (Act 35). Thereafter, the customer service robot 10 ends the check-in processing and returns to a main routine illustrated in FIG. 25.

Subsequently, a flow of processing performed by the server device 30 is explained.

The information managing unit 3141 acquires the user ID from the customer service robot 10 (Act 41).

The information managing unit 3141 outputs user information of the user corresponding to the user ID to the customer service robot 10 (Act 42).

The information managing unit 3141 acquires the store visiting purpose of the check-in user from the customer service robot 10 (Act 43).

The information managing unit 3141 outputs store information corresponding to the store visiting purpose to the customer service robot 10 (Act 44).

The information managing unit 3141 acquires the user features from the customer service robot 10 and stores the user features in the robot management table 3164 (Act 45).

Subsequently, the information managing unit 3141 stores the acquired user features in the robot management table 3164 to thereby update the robot management table 3164 and the user management table 3165 (Act 46). Thereafter, the server device 30 ends the operation relating to the check-in processing.

Note that, in FIG. 26, processing for a checked-in nonmember selecting a store that the nonmember desires to visit out of store information presented based on a store visiting purpose and registering a customer image of the nonmember is explained as the check-in processing. Processing for a checked-in member selecting a store that the member desires to visit out of a recommended store list presented based on a purchase history and a search history in the past of the member and registering a customer image of the member is explained as the check-in processing. In the check-in processing, the portions for selecting the store visiting purpose and selecting the store may be included in the action plan setting processing explained below.

### (Flow of the Action Plan Setting Processing Performed by the Customer Service Support System)

A flow of the action plan setting processing is explained with reference to FIG. 27. FIG. 27 is a flowchart illustrating an example of the flow of the action plan setting processing.

The customer service robot 10 cooperates with the server device 30 to thereby perform the action plan setting processing. First, a flow of processing performed by the customer service robot 10 is explained.

The action plan generating unit 1546 requests the server device 30 to output the map information 3161 (Act 51). Note that the processing only has to be performed only once after the check-in processing was completed. Alternatively, the customer service robot 10 may always store the latest map information 3161 in the storage unit 161 of the customer service robot 10.

The action plan generating unit 1546 acquires the map information 3161 from the server device 30 (Act 52).

The action plan generating unit 1546 determines whether a customer has a user ID (Act 53). Note that whether the customer has a user ID is determined based on a result of the check-in processing. If it is determined that the customer has a user ID (Yes in Act 53), the processing proceeds to Act 54. On the other hand, if it is not determined that the customer has a user ID (No in Act 53), the processing proceeds to Act 56.

If it is determined in Act 53 that the customer has a user ID, the action plan generating unit 1546 receives the store selection operation performed in Act 32 of the check-in processing and determines whether a plurality of stores that sell the same favorite commodity of the customer are present among stores selected by the customer (Act 54). If it is determined that a plurality of stores that sell the same favorite commodity of the customer are present (Yes in Act 54), the processing proceeds to Act 55. On the other hand, if it is not determined that a plurality of stores that sell the same favorite commodity of the customer are present (No in Act 54), the processing proceeds to Act 56.

If it is determined in Act 54 that a plurality of stores that sell the same favorite commodity of the customer are present, the action plan generating unit 1546 sets a moving route with the shortest moving distance while avoiding the stores that sell the same commodity (Act 55).

Subsequently, the action plan generating unit 1546 determines, based on operation information received by the operation receiving unit 1542, whether a route editing instruction was made (Act 57). If it is determined that the route editing instruction was made (Yes in Act 57), the processing proceeds to Act 58. On the other hand, if it is not determined that the route editing instruction was made (No in Act 57), the processing proceeds to Act 59.

If it is determined in Act 57 that the route editing instruction was made, the action plan generating unit 1546 resets a moving route according to instructed editing content (Act 58).

If it is not determined in Act 57 that the route editing instruction was made or following Act 58, the action plan generating unit 1546 outputs, to the server device 30, moving route information and store IDs of stores to be visited included in the moving route (Act 59). Thereafter, the customer service robot 10 ends the action plan setting processing and returns to the main routine illustrated in FIG. 25.

Subsequently, a flow of processing performed by the server device 30 is explained.

The information managing unit 3141 acquires an output request for the map information 3161 from the customer service robot 10 (Act 61).

The information managing unit 3141 outputs the map information 3161 to the customer service robot 10 (Act 62).

The information managing unit 3141 acquires, from the customer service robot 10, the moving route information and the store IDs of the stores to be visited included in the moving route (Act 63).

The information managing unit 3141 stores the acquired moving route information and the acquired store ID in the robot management table 3164 to thereby update the robot management table 3164 (Act 64). Thereafter, the server device 30 ends an operation relating to the action plan setting processing.

### (Flow of the Movement Control Processing Performed by the Customer Service Support System)

A flow of the movement control processing is explained with reference to FIG. 28. FIG. 28 is a flowchart illustrating an example of the flow of the movement control processing.

The customer service robot 10 cooperates with the server device 30 to thereby perform the movement control processing. First, a flow of the processing performed by the customer service robot 10 is explained.

The operation control unit 1544 determines whether the operation receiving unit 1542 received an instruction to change the customer service mode (Act 71). If it is determined that the operation receiving unit 1542 received the instruction to change the customer service mode (Yes in Act 71), the processing proceeds to Act 72. On the other hand, if it is not determined that the operation receiving unit 1542 received the instruction to change the customer service mode (No in Act 71), the processing proceeds to Act 73.

If it is s determined in Act 71 that the operation receiving unit 1542 received the instruction to change the customer service mode, the operation control unit 1544 changes the customer service mode from the leading mode to the following mode or from the following mode to the leading mode (Act 72). Note that, if arriving at a store, the customer service robot 10 may automatically shift to the following mode without waiting for an instruction of the customer.

The operation control unit 1544 recognizes a presence position of the customer out of an image captured by the imaging unit 143 (Act 73). Note that the operation control unit 1544 can more efficiently recognize the presence position of the customer by also using a presence position of the customer terminal 50 or a presence position of the beacon terminal explained above.

The operation control unit 1544 executes movement control for causing the customer service robot 10 to move in the leading mode or the following mode in a state in which a positional relation with the customer recognized in Act 73 is kept constant (Act 74). Note that, at this time, if an obstacle is present in the traveling direction, the operation control unit 1544 also performs movement control for, for example, causing the customer service robot 10 to temporarily stop before the obstacle or move while avoiding the obstacle.

The operation control unit 1544 specifies (dead-reckons) a present position of the customer service robot 10 in the commercial facility based on a positioning result of the positioning unit 159, speed and a moving direction of the customer service robot 10 detected by the sensor unit 158, and the map information 3161 (Act 75).

The operation control unit 1544 updates, based on the present position of the customer service robot 10 specified in Act 75, guidance information to be displayed on the guidance screen Ge (Act 76).

The operation control unit 1544 outputs the present position of the customer service robot 10 specified in Act 75 to the server device 30 (Act 77). Thereafter, the customer service robot 10 ends the movement control processing and returns to the main routine illustrated in FIG. 25.

Subsequently, a flow of processing performed by the server device 30 is explained.

The information managing unit 3141 acquires the present position from the customer service robot 10 (Act 81).

The information managing unit 3141 stores the acquired present position of the customer service robot 10 in the robot management table 3164 to thereby update the robot management table 3164 (Act 82). Thereafter, the server device 30 ends an operation relating to the movement control processing.

### (Flow of the Store Cooperation Processing Performed by the Customer Service Support System)

A flow of the store cooperation processing is explained with reference to FIG. 29. FIG. 29 is a flowchart illustrating an example of the flow of the store cooperation processing.

The customer service robot 10 cooperates with the store device 20 to thereby perform the store cooperation processing.

A flow of processing performed by the customer service robot 10 is explained.

If the customer service robot 10 entered a store, the store cooperation unit 1547 establishes connection in order to exchange information between the communication unit 160 of the customer service robot 10 and the communication unit 217 of the store device 20 (Act 91). Note that the connection established here is maintained until the customer service robot 10 leaves the store.

The store cooperation unit 1547 determines whether a commodity selected by the customer or a favorite commodity of the customer is present in the store (Act 92). Specifically, the store cooperation unit 1547 determines, for example, based on contents of the robot management table 3164 and the user management table 3165 acquired from the server device 30 and content of the commodity master 3163, whether a commodity selected by the customer or a favorite commodity of the customer is present in the store (not illustrated in FIG. 29). If it is determined that the relevant commodity is present in the store (Yes in Act 92), the processing proceeds to Act 93. On the other hand, if it is not determined that the relevant commodity is present in the store (No in Act 92), the customer service robot 10 ends the store cooperation processing and returns to the main routine illustrated in FIG. 25.

If it is determined in Act 92 that the relevant commodity is present in the store, the store cooperation unit 1547 outputs a commodity code of the relevant commodity to the store device 20 (Act 93). Thereafter, the customer service robot 10 ends the store cooperation processing and returns to the main routine illustrated in FIG. 25.

Subsequently, a flow of processing performed by the store device 20 is explained.

The communication control unit 2144 establishes connection in order to exchange information between the communication unit 217 of the store device 20 and the communication unit 160 of the customer service robot 10 (Act 101). Note that the connection established here is maintained until the customer service robot 10 leaves the store.

The robot cooperation unit 2142 determines whether a commodity code was acquired from the customer service robot 10 (Act 102). If it is determined that a commodity code was acquired (Yes in Act 102), the processing proceeds to Act 103. On the other hand, if it is not determined that a commodity code was acquired (No in Act 102), the store device 20 ends an operation relating to the store cooperation processing.

If it is determined in Act 102 that a commodity code was acquired, the robot cooperation unit 2142 outputs a light emission instruction to an electronic shelf label of a relevant commodity (Act 103). Consequently, since the electronic shelf label of the relevant commodity emits light, the customer can easily find the commodity. Note that, if the customer service robot 10 left the store and the connection established in Act 101 was interrupted, the store device 20 stops the light emission of the electronic shelf label (not illustrated in FIG. 29). Thereafter, the store device 20 ends an operation relating to the store cooperation processing.

### (Flow of the Purchase Support Processing Performed by the Customer Service Support System)

A flow of the purchase support processing is explained with reference to FIG. 30. FIG. 30 is a flowchart illustrating an example of the flow of the purchase support processing.

The customer service robot 10 cooperates with the store device 20 and the server device 30 to thereby perform the purchase support processing. The store device 20 and the server device 30 acquire a result of processing performed by the customer service robot 10 at any time and update the contents of the various tables stored by the store device 20 and the server device 30.

The customer service robot 10 cooperates with the store device 20 and the server device 30 to thereby execute the purchase support processing. However, since explanation is complicated, only processing performed by the customer service robot 10 is explained with reference to FIG. 30.

The purchase supporting unit 1548 determines whether a commodity code was input (Act 110). Specifically, if a code symbol or a wireless tag was read on the basic operation screen Gf explained above, the purchase supporting unit t 1548 determines that a commodity code was input. If it is determined that a commodity code was input (Yes in Act 110), the processing proceeds to Act 111. On the other hand, if it is not determined that the commodity code was input (No in Act 110), the processing proceeds to Act 121.

If it is determined in Act 110 that a commodity code was input, the purchase supporting unit 1548 causes the front display unit 132 to display the commodity screen Gg (Act 111).

Subsequently, the purchase supporting unit 1548 determines whether a recommendation request from the customer was made (Act 112). Specifically, if the operation piece Ggc was operated on the commodity screen Gg, the purchase supporting unit 1548 determines that the recommendation request was made. If it is determined that the recommendation request was made (Yes in Act 112), the processing proceeds to Act 113. On the other hand, if it is not determined that the recommendation request was made (No in Act 112), the processing proceeds to Act 114.

If it is determined in Act 112 that the recommendation request was made, the purchase supporting unit 1548 displays a recommended commodity on the commodity screen Gg. Note that, if a plurality of recommended commodities are present, one recommended commodity selected by selection operation of the customer is displayed on the commodity screen Gg (Act 113).

Subsequently, the purchase supporting unit 1548 determines whether a registration instruction for the commodity displayed on the commodity screen Gg was made (Act 114). Similarly, if it is not determined in Act 112 that the recommendation request was made, the purchase supporting unit 1548 determines whether a registration instruction for the commodity displayed on the commodity screen Gg was made (Act 114). Specifically, if detecting operation information of the operation piece Ggb displayed on the commodity screen Gg, the purchase supporting unit 1548 determines that the registration instruction for the commodity was made. If it is determined that the commodity registration instruction was made (Yes in Act 114), the processing proceeds to Act 115. On the other hand, if it is not determined that the commodity registration instruction was made (No in Act 114), the processing returns to Act 110. Note that, if the processing returns to Act 110, the basic operation screen Gf is displayed on the front display unit 132 of the customer service robot 10.

If it is determined in Act 114 that the commodity registration instruction was made, the purchase supporting unit 1548 performs commodity registration (Act 115). At this time, the purchase supporting unit 1548 registers the commodity in a state in which it is possible to identify whether the registered commodity is a store commodity or a provisional commodity. Thereafter, the processing returns to Act 110. Note that, at this time, the basic operation screen Gf is displayed on the customer service robot 10.

If the processing returns to Act 110 and it is not determined in Act 110 that a commodity code was input, the purchase supporting unit 1548 determines whether an instruction for virtual basket display was made (Act 121). Specifically, if the operation piece Gfg explained above was operated on the basic operation screen Gf, the purchase supporting unit 1548 determines that the instruction for virtual basket display was made. If it is determined that the instruction for virtual basket display was made (Yes in Act 121), the processing proceeds to Act 122. On the other hand, if it is not determined that the instruction for virtual basket display was made (No in Act 121), the processing proceeds to Act 131.

If it is determined in Act 121 that the instruction for virtual basket display was made, the purchase supporting unit 1548 displays a list screen of registered commodities (not illustrated) on the front display unit 132 of the customer service robot 10 (Act 122).

Subsequently, the purchase supporting unit 1548 determines whether commodity selection was performed on the list screen of the registered commodities (Act 123). If it is determined that commodity selection was performed (Yes in Act 123), the processing proceeds to Act 124. On the other hand, if it is not determined that commodity selection was performed (No in Act 123), the processing proceeds to Act 125.

If it is determined in Act 123 that commodity selection was performed, the purchase supporting unit 1548 displays, on the front display unit 132 of the customer service robot 10, the commodity screen Gg on which a selected commodity is displayed (Act 124).

The purchase supporting unit 1548 determines whether settlement was instructed on the commodity screen Gg (Act 125). Specifically, if the operation piece Gfh displayed on the commodity screen Gg was operated, the purchase supporting unit 1548 determines that settlement was instructed. If it is determined that settlement was instructed (Yes in Act 125), the processing proceeds to Act 132. On the other hand, if it is not determined that settlement was instructed (No in Act 125), the processing proceeds to Act 126.

If it is not determined in Act 125 that settlement was instructed, the purchase supporting unit 1548 determines whether a store leaving instruction was made from the customer (Act 126). Specifically, if the operation piece Gfc was operated on the basic operation screen Gf or the commodity screen Gg, the purchase supporting unit 1548 determines that the store leaving instruction was made from the customer. If it is determined that the store leaving instruction was made from the customer (Yes in Act 126), the processing proceeds to Act 127. On the other hand, if it is not determined that the store leaving instruction was made from the customer (No in Act 126), the processing returns to Act 110.

If it is determined in Act 126 that the store leaving instruction was made from the customer, the purchase supporting unit 1548 determines whether all store commodities among the registered commodities were already settled (Act 127). If it is determined that all the store commodities were already settled (Yes in Act 127), the customer service robot 10 ends the purchase support processing, returns to the main routine illustrated in FIG. 25, and guides the customer to the next store. On the other hand, if it is not determined that all the store commodities among the registered commodities were already settled (No in Act 127), the processing proceeds to Act 128.

If it is not determined in Act 127 that all the store commodities among the registered commodities were already settled, the purchase supporting unit 1548 causes the customer service robot 10 to inform to that effect (Act 128). Specifically, the purchase supporting unit 1548 causes the light emitting unit 141 of the customer service robot 10 to emit light or performs, on the front display unit 132, display indicating that unsettled store commodities are present to thereby inform that the unsettled store commodities are present. Thereafter, the processing returns to Act 110. The customer performs settlement of the unsettled store commodity.

If the processing returns to Act 121 and it is not determined in Act 121 that the instruction for virtual basket display was made, the purchase supporting unit 1548 determines whether a settlement instruction was made (Act 131). Specifically, if the operation piece Gfh was operated on the basic operation screen Gf or the commodity screen Gg, the purchase supporting unit 1548 determines that the settlement instruction was made from the customer. If it is determined that the settlement instruction was made (Yes in Act 131), the processing proceeds to Act 132. On the other hand, if it is not determined that the settlement instruction was made (No in Act 131), the processing proceeds to Act 141.

If it is determined in Act 131 that the settlement instruction was made, the purchase supporting unit 1548 displays a settlement method selection screen (not illustrated) on the front display unit 132 (Act 132). Choices such as “credit”, “cash”, “electronic money”, and “code settlement” are displayed on the settlement method selection screen. Note that, if it is determined in Act 125 that settlement was instructed, the processing in Act 132 is performed.

The purchase supporting unit 1548 receives selection of a choice on the settlement method selection screen (Act 133).

Subsequently, the purchase supporting unit 1548 executes the settlement instructed in Act 125 or Act 131 with the method received in Act 133 (Act 134).

Subsequently, the purchase supporting unit 1548 determines whether an instruction for a commodity receiving method was made from the customer (Act 135). Specifically, if a not-illustrated choice indicating “designate a receiving method” displayed on the front display unit 132 was operated, the purchase supporting unit 1548 determines that a receiving method was instructed. If it is determined that a commodity receiving method was instructed (Yes in Act 135), the processing proceeds to Act 136. On the other hand, if it is not determined that a commodity receiving method was instructed (No in Act 135), the processing returns to Act 126. Note that, if a receiving method was not instructed in Act 135, it is determined that the customer carries back a purchased commodity by himself or herself. In this case, the customer places the purchased commodity on the placing table 112 of the customer service robot 10 and causes the customer service robot 10 to convey the purchased commodity.

If it is determined in Act 135 that a commodity receiving method was instructed from the customer, the purchase supporting unit 1548 receives selection of a receiving method out of a commodity receiving method selection screen (not illustrated) displayed on the front display unit 132 (Act 136). Choices such as “send”, “receive at a counter”, “receive at a locker”, “receive at an exit”, and “receive at a parking lot” are displayed on the receiving method selection screen. The purchase supporting unit 1548 acquires a receiving method selected out of the choices. Note that, if a settled commodity is a provisional commodity, since the relevant commodity is sent later, only “send” and “receive at a counter” by visiting the store again as soon as a commodity arrives may be made selectable. On the other hand, if the settled commodity is a store commodity, all the choices explained above are made selectable.

The purchase supporting unit 1548 makes arrangement to receive the commodity with the receiving method selected in Act 136 (Act 137). Thereafter, the processing returns to Act 126.

If the processing returns to Act 131 and it is not determined in Act 131 that the settlement instruction was made, the purchase supporting unit 1548 determines whether an inquiry request was made (Act 141). Specifically, if the operation piece Gff was operated on the basic operation screen Gf or the commodity screen Gg, the purchase supporting unit 1548 determines whether an inquiry request was made from the customer. If it is determined that an inquiry request was made (Yes in Act 141), the processing proceeds to Act 142. On the other hand, if it is not determined that an inquiry request was made (No in Act 141), the processing returns to Act 126.

If it is determined in Act 141 that an inquiry request was made from the customer, the purchase supporting unit 1548 transmits inquiry information including the position and the like of the customer service robot 10 to the store device 20 (Act 142). Thereafter, the processing returns to Act 126.

Note that, in the store device 20 that received the inquiry information, the position and the like of the customer service robot 10 are notified to a terminal carried by a store clerk of the store, for example, according to control of the robot cooperation unit 2142 to urge the store clerk to attend the customer.

The customer service robot 10 may adjust a parking fee after shopping of the customer ended. At this time, for example, the purchase supporting unit 1548 calculates a parking time from the present time and a parking start time and calculates a parking fee corresponding to the parking time. The purchase supporting unit 1548 takes into account a discount of the parking fee based on a total amount of commodities purchased by the customer and, if adjustment of the parking fee is necessary, causes the customer to perform adjustment processing for the parking fee in short.

The embodiment is explained above. However, in the embodiment explained above, the programs to be executed by the devices including the customer service robot 10, the store device 20, the server device 30, the parking lot system 40, and the customer terminal 50 may be provided by being recorded in a computer-readable recording medium such as a CD-ROM. The programs to be executed by the devices may be provided by being stored on a computer connected to a network such as the Internet and downloaded through the network or may be provided through a network such as the Internet.

### ACTION EFFECTS OF THE EMBODIMENT

As explained above, the customer service robot 10 in the embodiment autonomously moves to support shopping of a customer in a commercial facility including a plurality of stores. The customer service robot 10 includes the action plan generating unit 1546 (the route setting unit) that sets, based on a store visiting purpose acquired from the customer, a store to be visited and a moving route in the commercial facility and the operation control unit 1544 (the movement control unit) that causes the customer service robot 10 to autonomously move along the moving route. Therefore, it is possible to perform customer service for a customer visiting a commercial facility for the first time (for example, a customer who did not perform user registration) equivalent to customer service for a customer accustomed to the commercial facility (for example, a customer who performed user registration).

In the customer service robot 10 in the embodiment, the action plan generating unit 1546 (the route setting unit) proposes a store to be visited in the commercial facility based on at least one of a commodity purchase history, a commodity search history, and interest and taste information estimated from the commodity purchase history and the commodity search history of the customer. Therefore, it is possible to further propose, to the customer who performed the user registration, a touring route on which the customer can purchase commodities matching preference of the customer.

In the customer service robot 10 in the embodiment, the action plan generating unit 1546 (the route setting unit) sets a moving route passing stores at the shortest moving distance if a favorite commodity of the customer is present in a plurality of stores. Therefore, it is possible to propose an efficient moving route.

The customer service robot 10 in the embodiment further includes the action plan generating unit 1546 (the route editing unit) that edits, according to an instruction of the customer, the moving route and the store to be visited set by the action plan generating unit 1546 and a staying time in the store to be visited. Therefore, it is possible to easily change the moving route according to preference of the customer.

Although the embodiment is explained above, the embodiment is an illustration and is not intended to limit the scope of disclosure. The new embodiment can be implemented in other various forms. Various omissions, substitutions, and changes can be made without departing from the gist of the disclosure. The embodiment and modifications thereof are included in the scope and the gist of the disclosure and included in the disclosure described in the claims and a scope of equivalents of the disclosure.

What is claimed is:

1. A customer service robot that autonomously moves to support shopping of a customer in a commercial facility including a plurality of stores, the customer service robot comprising:
a route setting component configured to set a store to be visited by the customer and a moving route in the commercial facility based on a store visiting purpose acquired from the customer; and
a movement controller configured to cause the customer service robot to autonomously move along the moving route.

2. The customer service robot according to claim 1, wherein the route setting component proposes the store to be visited in the commercial facility based on at least one of a commodity purchase history, a commodity search history, and interest and taste information estimated from the commercial purchase history and the commodity search history of the customer.

3. The customer service robot according to claim 1, wherein, if a favorite commodity of the customer is present in a plurality of stores, the route setting component sets a moving route passing the stores at a shortest moving distance.

4. The customer service robot according to claim 1, further comprising a route editing component configured to edit, according to an instruction of the customer, the moving route and the store to be visited set by the route setting component and a staying time in the store to be visited.

5. The customer service robot according to claim 1, further comprising a display to facilitate communication with the customer.

6. A method of controlling a customer service robot that autonomously moves to support shopping of a customer in a commercial facility including a plurality of stores, the method comprising:
setting a store to be visited and a moving route in the commercial facility based on a store visiting purpose acquired from the customer; and
causing the customer service robot to autonomously move along the moving route.

7. The method according to claim 6, further comprising:
proposing the store to be visited in the commercial facility based on at least one of a commodity purchase history, a commodity search history, and interest and taste information estimated from the commercial purchase history and the commodity search history of the customer.

8. The method according to claim 6, wherein, if a favorite commodity of the customer is present in a plurality of stores, further comprising:
setting a moving route passing the stores at a shortest moving distance.

9. The method according to claim 6, further comprising:
editing, according to an instruction of the customer, the moving route and the store to be visited set by the route setting component and a staying time in the store to be visited.

10. The method according to claim 6, further comprising:
displaying a message to facilitate communication with the customer.

11. A customer service support system, comprising:
a plurality of customer service robots that autonomously move to support shopping of a customer in a commercial facility including a plurality of stores, each customer service robot comprising:
a route setting component configured to set a store to be visited by the customer and a moving route in the commercial facility based on a store visiting purpose acquired from the customer; and
a movement controller configured to cause the customer service robot to autonomously move along the moving route;
a store device configured to execute processing relating to the store under control of a processor; and
a customer terminal,
wherein the customer service robot, the store device, and the customer terminal are connected to a network.

12. The customer service support system according to claim 11, further comprising a parking lot system configured to manage entering and leaving states and parking positions of vehicles.

13. The customer service support system according to claim 11, wherein the store device is a POS terminal or a store server provided in each of the stores present in the commercial facility.

14. The customer service support system according to claim 11, further comprising a positioning component configured to measure a present position of each of the customer service robots.

15. The customer service support system according to claim 14, wherein the positioning component comprises a GPS sensor and the positioning component is configured to makes use of beacon positioning.

16. The customer service support system according to claim 11, wherein the customer terminal is configured to facilitate payment processing in support of shopping of the customer.

17. The customer service support system according to claim 11, wherein the route setting component proposes the store to be visited in the commercial facility based on at least one of a commodity purchase history, a commodity search history, and interest and taste information estimated from the commercial purchase history and the commodity search history of the customer.

18. The customer service support system according to claim 11, wherein, if a favorite commodity of the customer is present in a plurality of stores, the route setting component sets a moving route passing the stores at a shortest moving distance.

19. The customer service support system according to claim 11, wherein the customer service robot further comprises a route editing component configured to edit, according to an instruction of the customer, the moving route and the store to be visited set by the route setting component and a staying time in the store to be visited.

20. The customer service support system according to claim 11, wherein the customer service robot further comprises a display to facilitate communication with the customer.
